(19) United States
(12) Patent Application Publication
(10) Pub. No.: US 2020/0214070 A1
(43) Pub. Date: Jul. 2, 2020

(54) METHOD AND USER EQUIPMENT (UE) FOR RECONNECTING RRC CONNECTION WITH RADIO ACCESS NETWORK (RAN) NODE

(71) Applicant: Samsung Electronics Co., Ltd, Suwon-si (KR)

(72) Inventors: Mangesh Abhimanyu INGALE, Banaglore (IN); Rajavelsamy RAJADURAI, Banaglore (IN); Anil AGIWAL, Suwon-si (KR)

(21) Appl. No.: 16/622,872

(22) PCT Filed: Jun. 14, 2018
(86) PCT No.: PCT/KR2018/006736

§ 371 Date: Dec. 13, 2019

(30) Foreign Application Priority Data
Jun. 14, 2017 (IN) 201741020837
Apr. 5, 2018 (IN) 201841013078
Jun. 13, 2018 (IN) 201842022152

(51) Int. Cl. H04W 76/19; H04W 74/08; H04W 76/27; H04W 36/30; H04W 12/06; H04W 12/10

(52) U.S. Cl. CPC H04W 76/19; H04W 74/0833; H04W 12/1006; H04W 36/305; H04W 12/06; H04W 76/27

(57) ABSTRACT

Accordingly the embodiments herein provide a method for reconnecting a Radio Resource Control (RRC) connection with a Radio Access Network (RAN) node by a User Equipment (UE) in a wireless communication system. The method includes transmitting a message 3 (MSG3) of a random access procedure on Signaling Radio Bearer 0 (SRB0) for reconnecting the RRC connection. The MSG3 is a request message to the RAN node with set of connection parameters. Further, the method includes receiving a message 4 (MSG4) of the random access procedure from the RAN node. The MSG4 is received on a SRB0 or a Signaling Radio Bearer 1 (SRB1). Furthermore, the method includes transmitting a message 5 (MSG5) on the SRB1 to RAN node for reconnecting RRC connection. The proposed method can be used to mitigate a replay attack on the UE in a inactive state using a nonce and a wait time interval.

### CROSS-REFERENCE TO RELATED APPLICATIONS

This application is a 371 of International Application No. PCT/KR2018/006736 filed on Jun. 14, 2018, which claims priority to Indian Provisional Patent Application No. 201741020837 filed on Jun. 14, 2017, Indian Provisional Patent Application No. 201841013078 filed on Apr. 5, 2018, and Indian Complete Patent Application No. 201842022152 filed on Jun. 13, 2018, the disclosures of which are herein incorporated by reference in their entirety.

### BACKGROUND

### 1. Field

The present disclosure is related to reconnecting a RRC connection of a user equipment (UE) in a wireless communication system. More particularly it is related to a method and system for a resume procedure and a re-establishment procedure initiated by the UE with a radio access network (RAN) node.

### 2. Description of the Related Art

In the recent years several broadband wireless technologies have been developed to meet the growing number of broadband subscribers and to provide more and better applications and services. The second generation wireless communication system has been developed to provide voice services while ensuring the mobility of users. Third generation wireless communication system supports not only the voice service but also data service. In recent years, the fourth wireless communication system has been developed to provide high-speed data service. However, currently, the fourth generation wireless communication system suffers from lack of resources to meet the growing demand for high speed data services. So fifth generation wireless communication system is being developed to meet the growing demand for high speed data services, support ultra-reliability and low latency applications.

The fifth generation wireless communication system will be implemented not only in lower frequency bands but also in higher frequency (mmWave) bands, e.g., 10 GHz to 100 GHz bands, so as to accomplish higher data rates. To mitigate propagation loss of the radio waves and increase the transmission distance, the beamforming, massive multiple-input multiple-output (MIMO), full dimensional MIMO (FD-MIMO), array antenna, an analog beam forming, large scale antenna techniques are being considered in the design of fifth generation wireless communication system. In addition, the fifth generation wireless communication system is expected to address different use cases having quite different requirements in terms of data rate, latency, reliability, mobility etc. However, it is expected that the design of the air-interface of the fifth generation wireless communication system would be flexible enough to serve the UEs having quite different capabilities depending on the use case and market segment the UE cater service to the end customer. Few example use cases the fifth generation wireless communication system wireless system is expected to address is enhanced mobile broadband (eMBB), massive machine type communication (m-MTC), ultra-reliable low latency communication (URLL) etc. The eMBB requirements like tens of Gbps data rate, low latency, high mobility so on and so forth address the market segment representing the conventional wireless broadband subscribers needing internet connectivity everywhere, all the time and on the go. The m-MTC requirements like very high connection density, infrequent data transmission, very long battery life, low mobility address so on and so forth address the market segment representing the internet of things (IoT)/internet of everything (IoE) envisioning connectivity of billions of devices. The URLL requirements like very low latency, very high reliability and variable mobility so on and so forth address the market segment representing the Industrial automation application, vehicle-to-vehicle/vehicle-to-infrastructure communication foreseen as one of the enabler for autonomous cars.

In LTE, Suspend and resume of RRC connection is specified to allow the eNB to suspend an RRC connection of n UE to be resumed by the UE at a later time. The UE may resume the RRC connection in the same or different eNB than where the suspend took place. The UE and eNB store the AS security context at suspend and reactivate the AS security context at resume. In LTE, when the RRC connection of the UE is suspended, the UE moves to IDLE state and the S1 connection (i.e. S1 bearer between eNB and SGW and the S1-AP connection) between eNB and MME is removed.

In LTE, when the eNB initiates the RRC Connection Suspend procedure, it may get new {NH, NCC} pair from the MME, based on the MME's local policy. Upon receipt of the S1-AP UE Context Suspend Response message from the MME and if the message includes a {NH, NCC} pair, the eNB shall store the fresh {NH, NCC} pair in the S1-AP UE Context Suspend Response message and remove any existing unused stored {NH, NCC} pairs.

When the eNB suspends the RRC connection of the UE, the eNB includes a Resume ID in the RRC connection suspend message to the UE. The resume ID is to be used for context identification and context transfer, when the UE resumes the RRC connection. The RRC Connection Suspend message is protected in PDCP layer using the current AS security context. The eNB shall store the Resume ID together with the UE context including the AS security context. The Resume ID includes the UE ID part and eNB ID part, however the UE is transparent to the composition of the Resume ID. The UE ID part of the Resume ID assigned by the eNB shall be different in consecutive suspends of the same UE. This is to avoid tracking of UEs based on the Resume ID.

If the eNB has a fresh {NH, NCC} pair, the eNB shall keep KRRCint and delete other keys of the AS security context, i.e. keys KeNB, KRRCenc, KUPenc shall be deleted after sending the RRC Connection Suspend message to the UE. Otherwise, if a fresh {NH, NCC} pair was not received from the MME the eNB shall keep the AS keys.

When the UE receives the RRC Connection Suspend message from the eNB, then the UE shall store the Resume ID together with the current UE context including the AS security context until the UE decides to resume the RRC connection.

FIG. 1 is a sequence diagram illustrates the RRC connection resume to a new eNB (success), according to a prior art. When the UE decides to resume the RRC connection, the UE 102 sends the RRC Connection Resume Request message on SRB0 and hence it is not integrity protected. The UE 102 shall include information to be used for UE context identification and UE verification in the RRC Connection Resume Request message. The Resume ID consists of UE ID part and eNB ID part based on which context is identified and a ShortResumeMAC-I which is an authentication token for UE verification. The full Resume ID is 40 bits including 20 MSB bits as eNB ID and 20 LSB bits as UE ID. The truncated version of Resume ID is 24 bits. The 24-bit truncated Resume ID using the 12 LSBs from the 20 MSBs of the received full Resume ID (i.e. b8˜b19) followed by the 12 LSBs of the full Resume ID (i.e. b28˜b39). The de-composition of the Resume ID is only know to the EUTRAN 104 i.e. eNB.

The ShortResumeMAC-I is a message authentication token, which shall be calculated with the following inputs: source C-RNTI, source PCI, resume constant and target Cell-ID and using the stored KRRCint used with the source eNB where the UE was suspended. The ShortResumeMAC-I shall be the 16 least significant bits of the output of the used integrity technique.

The target eNB (i.e. the eNB where the UE attempts resuming RRC connection) extracts the Resume ID and ShortResumeMAC-I from the RRC Connection Resume Request message. The target eNB contacts the source eNB based on the information in the Resume ID by sending a Retrieve UE Context Request message on X2 interface including the Resume ID, the ShortResumeMAC-I and Cell-ID of target cell, in order to retrieve the UE context including the AS security context.

The UE 102 shall set the contents of RRCConnectionResumeRequest message as follows: if field useFullResumeID is signalled in SystemInformationBlockType2 then UE set the resumeID to the stored resume Identity received in suspend message else set the truncated ResumeID to include bits in bit position 9 to 20 and 29 to 40 from the left in the stored resume Identity. The UE 102 sets the resume cause in accordance with the information received from upper layers or for mobile originated MMTEL Voice call. The UE 102 sets the shortResumeMAC-I to the 16 least significant bits of the MAC-I calculated using the inputs Target Cell-ID, C-RNTI last allocated and PCI of the cell where UE was suspended with the KRRCint key and the previously configured integrity protection technique, and with all input bits for COUNT, BEARER and DIRECTION set to binary ones.

The source eNB retrieves the stored UE context including the AS security context from its database identified by the Resume ID and the source eNB calculates and verifies the ShortResumeMAC-I using the same stored KRRCint and the parameters sent in Retrieve UE Context Request message.

If the source eNB has a fresh {NH, NCC} pair from the MME then that pair shall be used and the fresh NH shall be used as in the new KeNB* derivation. The source eNB responds with a Retrieve UE Context Response message to the target eNB on X2 interface including the UE context comprising the AS security context. The AS security context sent to the target eNB shall include the new derived KeNB*, the NCC associated to the KeNB*, the UE EPS security capabilities including the security algorithms supported by the UE 102 and ciphering and integrity algorithms used in the source cell. The target eNB derives new AS keys (RRC integrity key i.e. KRRCint, RRC encryption key i.e. KRRCenc and UP encryption key i.e. KUPenc) corresponding to the algorithms from the received KeNB*, reset all PDCP COUNTs to 0 and activates the new keys in PDCP layer. The target eNB responds with a RRC Connection Resume message including the NCC received from source eNB to the UE on SRB1, integrity protected in PDCP layer using the new AS keys.

When the UE 102 receives the RRC Connection Resume message, then the UE 102 shall check if the received NCC value is different from the current NCC value stored in the UE itself. If the NCC values differ then the UE 102 needs to synchronize its locally kept NH. The UE 102 then calculates a new KeNB* from either the new NH (if a new NCC value was received) or the current KeNB*, using the target cell's PCI and its frequency EARFCN-DL in the target cell. The UE 102 performs then further derivation of the AS keys (RRC integrity key i.e. KRRCint, RRC encryption key i.e. KRRCenc and UP encryption key i.e. KUPenc) from the new derived KeNB*. The UE 102 checks the integrity of the RRC Connection Resume message by verifying the MAC-I. If the verification of the MAC-I is successful, then the UE 102 resets all PDCP COUNTs to 0 and activates the new AS keys in PDCP layer. The UE then sends the RRC Connection Resume Complete message both integrity protected and ciphered to the target eNB on SRB1.

Security is fully resumed on UE side after reception and processing of RRC connection resume message. The UE 102 can receive data on DRB(s) after having received and processed RRC connection resume message. UL data on DRB(s) can be sent after RRC Connection Resume Complete message.

After a successful resume the target eNB shall perform Path Switch procedure as is done in case of X2-handover. The Resume procedure for the success case in depicted in the FIG. 1.

The target eNB may be the same as the source eNB in the description in the previous subclause. If so the single eNB performs the roles of both the source and target eNB. In particular, a new KeNB* shall be derived even if the UE is resuming to the same cell from where it was suspended. However, there is the following difference.

RRC connection resume to the same eNB: After a successful resume the eNB shall send S1-AP UE Context Resume Request message to the MME. Upon reception of the S1-AP UE Context Resume Request message the MME shall check its local policy. If the local policy in the MME indicates that a new NH derivation is needed, the MME shall increase its locally kept NCC value by one and compute a fresh NH from its stored data. The MME shall store that fresh pair and send it to the eNB in the S1-AP UE Context Resume Response message.

Upon receipt of the S1-AP UE Context Resume Response message from the MME and if the message includes a {NH, NCC} pair, the eNB shall store the fresh {NH, NCC} pair received in the S1-AP UE Context Resume Response message and remove any existing unused stored {NH, NCC} pairs. The {NH, NCC} pair may be used in the next suspend/resume or X2-handover procedures.

FIG. 2 is a sequence diagram illustrates the RRC connection resume reject, according to a prior art. In case if the target eNB not able to accommodate the UE 102 at that particular time (for example, due to overload condition), then the eNB 104 rejects the connection with a wait time, for the UE's RRC connection Resume Request which includes the Short MAC-I. The reject message is sent on SRB0 i.e., it is not protected. If the UE 102 receives the reject message with the wait time, then the UE 102 attempts the connection again with the same Short MAC-I after the expiry of wait time.

The issue here (in case of RRC Connection Reject) is that, if the attacker knows the short MAC-I (for example, when performing the initial RRC connection Resume Request), then the attacker can replay the same RRC connection Resume Request with the Short MAC-I and make the eNB 104 to enable the active context resulting in context re-location from old eNB to new eNB. By doing so, the RRC state of genuine UE is not aligned with the eNB, therefore the genuine UE resume re-attempt afterwards will fail. So the attacker can mount denial of service (DOS) attack on the genuine UE 102 by replaying the shortMAC-I. Since the Short MAC-I does not have any refreshing parameter, if the same Short MAC-I is used again in resume re-attempt after reject, which makes the attacker to mount the replay attack successfully.

In case of resume reject from a eNB/gNB, a UE 102 already expose a Short MAC-I when attempting to resume in the same cell, then an attacker captures the Short MAC-I and can send the Short MAC-I on behalf of the genuine UE 102 (mount replay attack), which leads to DoS attack on the genuine UE.

Further, in LTE, re-establishment procedure was introduced in Rel-8 with the intention to re-establish the RRC connection, which involves the resumption of SRB1 operation, the re-activation of security and the configuration of only a PCell. The re-establishment procedure is triggered in following conditions: a) upon detecting RLF, b) upon HO failure, c) mobility from E-UTRA failure, d) IP check failure on SRB and e) RRC connection re-configuration failure. The trigger conditions for the re-establishment procedure in NR would remain same as in LTE except condition c) where it may be due to mobility from NR failure. The purpose of such procedure (i.e. mobility from NR) would be to move a UE in RRC_CONNECTED on a NR cell to a LTE cell. It can be observed that re-establishment procedure can be triggered by UE 102 having active security. For NR it needs to be discussed further apart from resumption of SRB1 operation, whether SRB2 and DRBs can be resumed with the re-establishment procedure.

For NR it is desirable if SRB2 and DRBs can be resumed with the re-establishment procedure apart from resumption of SRB1 operation. This would be an enhancement of re-establishment procedure in NR compared to LTE procedure.

This can be achieved if the NR INACTIVE resume procedure is harmonized with NR re-establishment procedure on RRC and Xn interfaces. Harmonization of the re-establishment and resume messages and procedure can be achieved if the security framework applied to both procedures is similar. Also, Xn procedure for UE context retrieval can be harmonized for re-establishment and resume. The purpose of the resume procedure is to resume an RRC connection which involves resuming SRB(s) and DRB(s) or perform an RAN update. The resume procedure is triggered in following conditions when the UE is in INACTIVE state a) arrival of UL data, b) responding to RAN paging and c) RNA update triggered. Even though the trigger conditions for re-establishment and resume are different the final outcome is same i.e. resumption of RRC connection or reconnection of the RRC connection.

Transmission of Re-establishment Request message in LTE is extracted below. The UE actions related to transmission of re-establishment request message from TS 36.331 is shown below:

The actions related to transmission of RRCConnectionReestablishmentRequest message.

Except for NB-IoT, if the procedure was initiated due to radio link failure or handover failure, the UE shall:

set the reestablishmentCellId in the VarRLF-Report to the global cell identity of the selected cell;

The UE shall set the contents of RRCConnectionReestablishmentRequest message as follows:

set the ue-Identity as follows:

set the c-RNTI to the C-RNTI used in the source PCell (handover and mobility from E-UTRA failure) or used in the PCell in which the trigger for the re-establishment occurred (other cases);

set the physCellId to the physical cell identity of the source PCell (handover and mobility from E-UTRA failure) or of the PCell in which the trigger for the re-establishment occurred (other cases);

set the shortMAC-I to the 16 least significant bits of the MAC-I calculated:

over the ASN.1 encoded as per section 8 (i.e., a multiple of 8 bits) VarShortMAC-Input (or VarShortMAC-Input-NB in NB-IoT);

with the K_{RRcint} key and integrity protection algorithm that was used in the source PCell (handover and mobility from E-UTRA failure) or of the PCell in which the trigger for the re-establishment occurred (other cases); and

with all input bits for COUNT, BEARER and DIRECTION set to binary ones;

Based on the above bold text, it can be observed for the calculation of MAC-I, when the re-establishment is triggered due to b) upon HO failure or c) mobility from E-UTRA failure the security key in the source PCell is used and for UE ID the C-RNTI, PCI is of the source PCell. For other conditions i.e. a) upon detecting RLF, d) IP check failure on SRB and e) RRC connection re-configuration failure as highlighted in bold text the security key in the current PCell is used for MAC-I calculation and the UE ID is set to C-RNTI, PCI of the current PCell.

Security key in the source PCell is used for MAC-I calculation and UE ID set C-RNTI, PCI from the source PCell when re-establishment is triggered upon HO failure or mobility from E-UTRA failure conditions.

Security key in the current PCell is used for MAC-I calculation and UE ID set C-RNTI, PCI from the current PCell when re-establishment is triggered upon RLF failure, IP check failure or Re-configuration failure conditions.

In NR for the HO cases, the re-establishment procedure should handle HO failure case regardless of the target is unprepared or prepared.

The above information on LTE resume procedure and LTE re-establishment procedure is presented as background information only to help the reader to understand the present invention. Applicants have made no determination and make no assertion as to whether any of the above might be applicable as Prior Art with regard to the present application.

### SUMMARY

The principal aspect of the embodiments herein is to provide a method and user equipment (UE) for reconnecting a RRC connection with a radio access network (RAN) node.

Another aspect of the embodiments herein is to transmit a message 3 (MSG3) of a random access procedure on signaling radio bearer 0 (SRB0) with a set of connection parameters including a UE identifier (UE ID), a first authentication token, a reconnect cause value to reconnect the RRC connection and a next hop chaining counter (NCC) for reconnecting the RRC connection.

Another aspect of the embodiments herein is to transmit a RRC resume request message (i.e., MSG 3) on SRB0 to the RAN node to transition from an inactive state to a connected state.

Another aspect of the embodiments herein is to transmit a RRC reestablishment request message (i.e., MSG 3) on SRB0 from the connected state to reestablish the RRC connection with the RAN node.

Another aspect of the embodiments herein is to receive a message 4 (MSG4) of the random access procedure from the RAN node on SRB0 or SRB1.

Another aspect of the embodiments herein is to receive RRC Reject message (MSG 4) on SRB0 from the RAN node, wherein the Reject message indicates the UE to move to an inactive state. The Reject message includes at least one of a Nonce and a wait time interval.

Another aspect of the embodiments herein is to receive Setup message (MSG 4) on SRB0 from the RAN node, wherein the Setup message indicates the UE to fallback to an idle state.

Another aspect of the embodiments herein is to receive a RRC message (MSG4) on SRB1 from the RAN node, wherein the RRC message is received in response to a Resume request to transition the UE to a connected state or an idle state or an inactive state. The RRC message sent on SRB1 is integrity protected with a new RRC integrity security key (i.e. KRRCint) and ciphered with a new RRC encryption security key (i.e. KRRCenc).

Another aspect of the embodiments herein is to receive a RRC message (MSG4) on SRB1 from the RAN node, wherein the RRC message received on the SRB1 is a RRC Resume message to move the UE to connected state comprising parameters to resume the data radio bearers (DRBs).

Another aspect of the embodiments herein is to receive a RRC message (MSG4) on SRB1 from the RAN node, wherein the RRC message received on the SRB1 is a RRC Release message comprising one of: an explicit indicator and an implicit indicator to move the UE to one of: inactive state and idle state.

Another aspect of the embodiments herein is to receive a RRC reestablishment message on SRB1 from the RAN node, wherein the reestablishment message is received in response to a reestablishment request message from the UE. The reestablishment message is integrity protected with a new RRC integrity security key and ciphered with a new RRC encryption security key.

Another aspect of the embodiments herein is to transmit a message 5 (MSG5) on the SRB1 to the RAN node for reconnecting the RRC connection.

Another aspect of the embodiments herein is to retransmit the Resume request message to the RAN node after expiry of the wait time interval, wherein the retransmitted resume request comprises at least one of UE ID, the second authentication token, and a reconnect cause value.

Another aspect of the embodiments herein is to determine the second authentication token using at least one of a last serving cell derive the second authentication token based on last allocated C-RNTI, a last serving cell physical cell identifier (PCI), a target cell ID and one of Nonce and wait time interval calculated using the RRC integrity security key of last serving cell.

Another aspect of the embodiments herein is to mitigate a DoS attack on the UE in inactive state using the Nonce provided in the reject message.

Another aspect of the invention is to mitigate the DoS attack on the UE in inactive state using the wait time interval provided in the reject message.

Accordingly the embodiments herein provide a method for reconnecting a radio resource control (RRC) connection with a radio access network (RAN) node by a user equipment (UE) in a wireless communication system. The method includes transmitting a message 3 (MSG3) of a random access procedure on a signaling radio bearer 0 (SRB0) for reconnecting the RRC connection. The MSG3 is a request message to the RAN node with a set of connection parameters. Further, the method includes receiving a message 4 (MSG4) of the random access procedure from the RAN node. The MSG4 is received on the SRB0 or a signaling radio bearer 1 (SRB1). Furthermore, the method includes transmitting a message 5 (MSG5) on the SRB1 to the RAN node for reconnecting the RRC connection.

In an embodiment, the set of connection parameters in the request message includes at least one of: a UE identifier (UE ID), a first authentication token, a reconnect cause value to reconnect the RRC connection and a next hop chaining counter (NCC).

In an embodiment, the UE ID is either a resume identifier (i.e. Resume ID), referred as implicit radio network temporary identifier (I-RNTI) or a last serving cell allocated C-RNTI and a last serving cell physical cell identifier (PCI). The UE ID regardless of Resume ID or C-RNTI and PCI combination is used for identifying the UE context at the RAN node.

In an embodiment, the first authentication token is shortened message authentication code for integrity check (MAC-I) referred as ShortMAC-I or ShortResumeMAC-I. The ShortMAC-I is determined using at least one of a last serving cell allocated C-RNTI, a last serving cell physical cell identifier (PCI), and a target cell ID calculated using the RRC integrity security key of the last serving cell.

In an embodiment, the MSG3 for reconnecting the RRC connection is a RRC resume request message transmitted to the RAN node to transition from an inactive state to a connected state or a RRC reestablishment request message transmitted to the RAN node from the connected state to reestablish the RRC connection.

In an embodiment, the MSG4 received on the SRB0 is either a RRC Reject message to move the UE to an inactive state or a RRC Setup message to indicate the UE to fallback to an idle state.

In an embodiment, the MSG4 received on the SRB1 is a RRC message responded to the request message to transition the UE to either RRC connected state or RRC idle state or RRC inactive state, wherein the RRC message is integrity protected with a new RRC integrity security key and ciphered with a new RRC encryption security key.

In an embodiment, the new RRC integrity security key and new RRC encryption key used for security protection of RRC message sent on SRB1 (i.e. MSG4) is derived using either vertical key derivation or horizontal key derivation.

In an embodiment, the RRC message (i.e. MSG4) received on SRB1 from the RAN node is a RRC Resume message to move the UE to connected state comprising parameters to resume the data radio bearers (DRBs).

In an embodiment, the RRC message (i.e. MSG4) received on SRB1 from the RAN node is a RRC Release message comprising one of: an explicit indicator and an implicit indicator to move the UE either to RRC inactive state or RRC idle state.

In an embodiment, the RRC Release message received on SRB1 includes at least a new Resume ID, new paging parameters and new NCC which is an implicit indicator to move the UE back to RRC inactive state.

In an embodiment, if the RRC Release message received on SRB1 does not include at least a new Resume ID, new paging parameters and new NCC is an implicit indicator to transition the UE to RRC idle state.

In an embodiment, the MSG4 received on the SRB1 is a RRC reestablishment message responded to the RRC reestablishment request message, wherein the RRC reestablishment message is integrity protected with a new RRC integrity security key and ciphered with a new RRC encryption security key.

In an embodiment, the new RRC integrity security key and new RRC encryption key used for security protection of the RRC reestablishment message is derived always using horizontal key derivation.

In an embodiment, the Reject message to move UE to the inactive state, responded to the resume request message comprises at least one of a Nonce and a wait time interval.

In an embodiment, the retransmission of the Resume request message to the RAN node after expiry of the wait time interval comprises at least one of UE ID, the second authentication token, and a reconnect cause value.

In an embodiment, the second authentication code referred as ShortMAC-I is determined using at least one of a last serving cell allocated C-RNTI, a last serving cell physical cell identifier (PCI), a target cell ID and either a Nonce or a wait time interval value calculated using the RRC integrity security key of last serving cell.

Accordingly the embodiments herein provide a method for reconnecting a radio resource control (RRC) connection of a user equipment (UE) by a radio access network (RAN) node, in a wireless communication system. The method includes receiving a request message from the UE with a set of connection parameters for reconnecting the RRC connection. The method includes identifying a stored context of the UE and verifying the UE which sent the request message. Further, the method includes transmitting a response message on SRB1 to the UE in response to identifying and verifying the stored UE context. Furthermore, the method includes transmitting a RRC message to the UE on signaling radio bearer 0 (SRB0) upon determining either the stored UE context cannot be retrieved or the RAN node is congested.

In an embodiment, the RAN node transmits a RRC resume message to the UE on SRB1 to move the UE to connected state in response to the resume request message which includes at least the reconnect cause value indicating resuming the RRC connection. The RRC resume message sent on SRB1 includes parameters to resume the data radio bearers (DRBs).

In an embodiment, the RAN node transmits a RRC release message to the UE on SRB1 to move the UE back to inactive state in response to the resume request message which includes at least the reconnect cause value indicating RAN paging area update. The RRC release message sent on SRB1 to move UE back to RRC inactive state includes at least a new Resume ID, new paging parameters and a new NCC. In another embodiment, if the RRC release message sent on SRB1 does not include a new Resume ID, new paging parameters and a new NCC, it is implicit indication to the UE to transition to RRC idle state.

In an embodiment, the RAN node transmits a RRC release message to the UE on SRB1 to move the UE back to idle state in response to the resume request message; wherein the RRC release message includes an explicit indicator to release the RRC connection.

In an embodiment, the RAN node transmits RRC a reestablishment message to the UE on SRB1 in response to the reestablishment request message which includes at least the reconnect cause value indicating reestablishing the RRC connection. The RRC reestablishment message sent on SRB1 includes parameters to resume the DRBs.

In an embodiment, the RAN node transmitted RRC message to the UE on SRB0 in response to the resume request message is a RRC Reject message upon determining a RAN congestion condition.

In an embodiment, the RAN node transmitted RRC message to the UE on SRB0 in response to either the RRC resume request message or the RRC reestablishment request message is a RRC Setup message upon determining that the context of the UE is not retrieved.

Accordingly the embodiments herein provide a User Equipment (UE) for reconnecting a radio resource control (RRC) connection with a radio access network (RAN) node in a wireless communication system. The UE is configured to transmit a message 3 (MSG3) of a random access procedure on signaling radio bearer 0 (SRB0) for reconnecting the RRC connection. The MSG3 is a request message to the RAN node with a set of connection parameters. Further, the UE is configured to receive a message 4 (MSG4) of the random access procedure from the RAN node, wherein the MSG4 is received on either a SRB0 or a signaling radio bearer 1 (SRB1). Furthermore, the UE is configured to transmit a message 5 (MSG5) on the SRB1 to the RAN node for reconnecting the RRC connection.

Accordingly the embodiments herein provide a radio access network (RAN) node for reconnecting a radio resource control (RRC) connection of a user equipment (UE) in a wireless communication system. The RAN node configured to receive a request message from the UE with a set of connection parameters for reconnecting the RRC connection. The RAN node is configured to identify a stored context of the UE and verify the UE which sent the request. Further, the RAN node is configured to transmit a RRC message on SRB1 to the UE in response to identifying and verifying the stored UE context. Furthermore, the RAN node is configured to transmit a RRC message to the UE on signaling radio bearer 0 (SRB0) upon determining either the stored UE context is not retrieved or RAN congestion condition.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

This method is illustrated in the accompanying drawings, throughout which like reference letters indicate corresponding parts in the various figures. The embodiments herein will be better understood from the following description with reference to the drawings, in which:

FIG. 1 is a sequence diagram illustrates a radio resource control (RRC) connection resume procedure to a new eNB (success), according to a prior art;

FIG. 2 is a sequence diagram illustrates a RRC connection resume reject, according to a prior art;

FIG. 3 is a high level overview of a new radio (NR) RRC state machine with possible transitions between RRC states, according to the embodiments as disclosed herein;

FIGS. 4A-4G are flow diagrams illustrating a method for reconnecting a RRC connection with a radio access network (RAN) node by a user equipment (UE) in a wireless communication system, according to an embodiment as disclosed herein;

FIG. 5A is a sequence diagram in which the UE sends a connection resume request message for resuming the RRC connection with the RAN node, according to an embodiment as disclosed herein;

FIG. 5B is a sequence diagram in which the UE sends a connection reestablishment request message for reestablishing the RRC connection with the RAN node, according to an embodiment as disclosed herein;

FIG. 6A-6B are flow diagrams illustrating a method for reconnecting a RRC connection of a UE by a RAN node, in a wireless communication system, according to an embodiment as disclosed herein;

FIG. 7 is a flow diagram illustrating various steps performed by the RAN node based on retrieval of a stored context of the UE, according to an embodiment as disclosed herein;

FIG. 8 is a sequence diagram in which the UE resumes the RRC connection with a RAN node using a nonce generated by the RAN node, according to the embodiments as disclosed herein;

FIG. 9 is a sequence diagram in which the UE resumes a RRC connection with another RAN node during mobility, according to the embodiments as disclosed herein.

FIG. 10 is a sequence diagram in which the resumes a RRC connection with another RAN node using a nonce where the nonce is provided by the another RAN node, according to the embodiments as disclosed herein;

FIG. 11 is a sequence diagram in which the UE resumes the RRC connection with the RAN node using a wait timer value, according to the embodiments as disclosed herein;

FIG. 12 is a sequences diagram in which the UE resumes the RRC connection in another RAN node using a cell Identifier of another node, according to the embodiments as disclosed herein;

FIG. 13 is a sequence diagram in which the UE resumes the RRC connection using a wait Timer provided by another RAN node, according to the embodiments as disclosed herein;

FIG. 14 is a sequence diagram in which the UE resumes the RRC connection with the RAN node using the wait Timers, according to the embodiments as disclosed herein;

FIG. 15 is a block diagram illustrating various modules of the UE, according to an embodiment as disclosed herein; and

FIG. 16 is a block diagram illustrating various modules of the RAN node, according to an embodiment as disclosed herein.

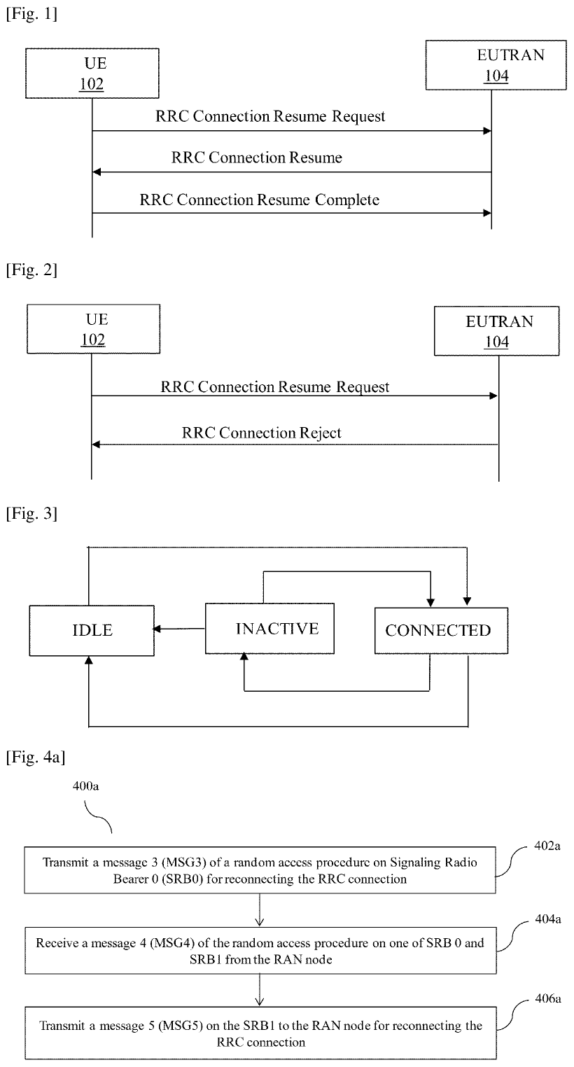

### DETAILED DESCRIPTION

Embodiments of the present disclosure are described with reference to the accompanying drawings.

The present disclosure may omit descriptions of technologies that are known to those skilled in the art and are not directly related to the present disclosure.

In the accompanying drawings, some elements may be exaggerated, omitted, or schematically illustrated. Further, the size of each element does not necessarily reflect the actual size. In the drawings, identical or corresponding elements may be provided with identical reference numerals.

The present disclosure is not limited to the embodiments set forth below, but may be implemented in various forms.

Computer program instructions may implement each block, and combinations of blocks, in the flowchart illustrations.

The computer program instructions can be provided to a processor of a general purpose computer, special purpose computer, or other programmable data processing apparatus, such that the instructions, which execute via the processor of the computer or other programmable data processing apparatus, create a means for implementing the functions specified in the block or blocks of flowchart.

The computer program instructions may also be stored in a computer usable or computer-readable memory that may direct a computer or other programmable data processing apparatus to function in a particular manner, such that the instructions stored in the computer usable or computer-readable memory may produce an article of manufacture including an instruction means that implements the function specified in the flowchart block or blocks.

The computer program instructions may also be loaded onto a computer or other programmable data processing apparatus to cause a series of operational steps to be performed on the computer or other programmable apparatus to produce a computer implemented process such that the instructions provide steps for implementing the functions specified in the flowchart block or blocks.

Further, each block of the flowchart illustrations may represent a module, segment, or portion of code, which includes one or more executable instructions for implementing the specified logical function or functions. In some alternative implementations, the functions noted in the blocks may occur out of order. For example, two blocks shown in succession may in fact be executed at or about the same time, or the blocks may sometimes be executed in reverse order, depending upon the functionality involved.

As used herein, the terms “unit” or “module” refer to a software element or a hardware element, such as a field programmable gate array (FPGA) or an application specific integrated circuit (ASIC), which performs a predetermined function. However, the “unit” or “module” does not always have a meaning limited to software or hardware. The “unit” or “module” may be constructed either to be stored in an addressable storage medium or to execute one or more processors. Therefore, the “unit” or “module” includes, for example, software elements, object-oriented software elements, class or task elements, processes, functions, properties, procedures, sub-routines, segments of a program code, drivers, firmware, micro-codes, circuits, data, database, data structures, tables, arrays, and parameters.

Elements and functions provided by “units” may either be divided into a smaller number of elements and “units”, or combined into a larger number of elements and “units”. Moreover, the elements, “units”, or “modules” may be implemented to reproduce one or more central processing units (CPUs) within a device or a security multimedia card. Further, a “unit” may include at least one processor.

A communication system can effectively transmit data by using different types of services, and provide a method that allows for the coexistence of data transmissions in different types of services, so as to satisfy requirements of the services. Thus, the communication system can reduce a delay in transmission time and enable efficient use of frequency-time resources or spatial resources.

A wireless communication system has been developed from an initial wireless communication system providing a voice-based service to a broadband wireless communication system providing a high speed and high quality packet data service, such as a high speed packet access (HSPA) of 3rd generation partnership project (3GPP), LTE, evolved-universal terrestrial radio access (E-UTRA), LTE-Advanced, high rate packet data (HRPD) of 3GPP2, ultra mobile broadband (UMB), and communication standards of the Institute of electrical and electronics engineers (IEEE) 802.16e. Further, 5G or new radio (NR) communication standards are being made for a 5th generation wireless communication system.

In a 5th generation wireless communication system, at least one service of enhanced mobile broadband (eMBB), massive MTC, and ultra-reliable and low latency communications (URLLC) may be provided to a terminal or a user equipment (UE). The services enumerated above may be provided to an identical terminal during an identical time interval.

According to an embodiment, the eMBB may be a service targeted at high speed transmission of large capacity data, the mMTC may be a service targeted at minimizing terminal power and access of multiple terminals, and the URLLC may be a service targeted at high reliability and low delay. The above three services may be important services in an LTE system or in a system of 5G/NR. A method of eMBB coexisting with URLLC or mMTC coexisting with URLLC, and an apparatus using the same will be discussed.

When a base station has data scheduled to be transmitted to a terminal corresponding to an eMBB service in a particular transmission time interval (TTI), and is in a situation requiring transmission of URLLC data in the TTI, the base station may transmit the URLLC data, instead of a part of the eMBB data, in a frequency band through which the base station is already transmitting the eMBB data through the scheduling. A terminal having received the scheduled eMBB data and a UE having received the scheduled URLLC may either be the same terminal or different terminals.

In one case, since a part of the eMBB data being scheduled is not transmitted, the possibility that the eMBB data may be damaged increases. Therefore, it is necessary to determine a method for receiving a signal and processing the received signal by a terminal having already received the scheduled eMBB data or the scheduled URLLC.

Therefore, according to an embodiment, a method for different services coexisting to enable transmission of information according to each service when eMBB and URLLC information is scheduled through a partly or entirely shared frequency band, when mMTC and URLLC information is simultaneously scheduled, when mMTC and eMBB information is simultaneously scheduled, or when eMBB, mMTC, and URLLC information is simultaneously scheduled, is discussed.

In the following description, a base station is a subject for performing allocation of a resource for a terminal, and may be at least one of a gNode B, an eNode B, a Node B, a base station (BS), a wireless access unit, a base station controller, and a network node. A terminal may include a UE, a mobile station (MS), a cellular phone, a smart phone, a computer, or a multimedia system capable of performing a communication function. In the present disclosure, a downlink (DL) is a wireless transmission path through which a BS transmits a signal to a terminal, and an uplink (UL) is a wireless transmission path through which a terminal transmits a signal to a BS.

Further, embodiments of the present disclosure are discussed as an example of an LTE or LTE-A system. However, the embodiments of the present disclosure may be applied to other communication systems having similar technical backgrounds or channel types. For example, such other communication systems may include a system using 5G, NR, or other systems developed after LTE-A. Further, embodiments of the present disclosure may be applied to other communication systems through partial modification thereof within a range determined by those skilled in the art not to coincide with the scope of the present disclosure.

The LTE system, as a representative example of a broadband wireless communication system, employs an orthogonal frequency division multiplexing (OFDM) scheme for the downlink and a single carrier frequency division multiple access (SC-FDMA) scheme for the uplink. The uplink is a wireless link through which a terminal (or a UE or MS) transmits data or a control signal to a base station (or a gNode B), and the downlink is a wireless link through which a base station transmits data or a control signal to a terminal. In the multiple access schemes as described above, time-frequency resources for carrying data or control information may be allocated and operated in a manner to prevent overlapping of the resources (i.e., to establish the orthogonality, between users), so as to identify data or control information of each user.

The LTE system employs a hybrid automatic repeat request (HARQ) scheme in which, when decoding of initially-transmitted data fails, the data is retransmitted in a physical layer. In the HARQ scheme, when a receiver fails to accurately decode data, the receiver may transmit a negative acknowledgement (NACK) notifying of a decoding failure to a transmitter to enable the transmitter to retransmit the data in a physical layer. The receiver may combine the data retransmitted by the transmitter with the decoding-failed data to enhance the data reception capability. Further, when the receiver has accurately decoded data, the receiver may transmit an acknowledgement (ACK) notifying of a decoding success to a transmitter to enable the transmitter to transmit new data.

As discussed below, a higher layer signal, which is a signal, such as a signal indicator bit (SIB), a radio resource signal (RRC), a media access control (MAC), or a control element (CE), semi-statically or statically supports a particular operation control of a terminal, and a physical signal, which is a layer 1 (L1) signal, dynamically supports a particular operation control of a terminal in the form of terminal-common downlink control information or terminal-specific downlink control information.

Various embodiments of the present disclosure will now be described in detail with reference to the accompanying drawings. In the following description, specific details such as detailed configuration and components are merely provided to assist the overall understanding of these embodiments of the present disclosure. Therefore, it should be apparent to those skilled in the art that various changes and modifications of the embodiments described herein can be made without departing from the scope and spirit of the present disclosure. In addition, descriptions of well-known functions and constructions are omitted for clarity and conciseness.

Also, the various embodiments described herein are not necessarily mutually exclusive, as some embodiments can be combined with one or more other embodiments to form new embodiments. Herein, the term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units or modules or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Throughout the description, the term radio access network (RAN) node refers to a Long Term Evolution (LTE) base station (i.e., an evolved nodeB (eNB)) or a new radio (NR) base station (i.e., a gNB). It should be noted that the eNB or the gNB can have a plurality of cells which serves a plurality of UEs. Throughout the description, the term shortMAC-I and shortResumeMAC-I refer to the authentication token. Throughout the description, the terms suspend state and inactive state are used interchangeably.

Accordingly the embodiments herein provide a method for reconnecting a radio resource control (RRC) connection with a RAN node by a user equipment (UE) in a wireless communication system. The method includes transmitting a message 3 (MSG3) of a random access procedure on a signaling radio bearer 0 (SRB0) for reconnecting the RRC connection. The MSG3 is a request message to the RAN node with a set of connection parameters. Further, the method includes receiving a message 4 (MSG4) of the random access procedure from the RAN node. The MSG4 is received on one of: a SRB0 and a signaling radio bearer 1 (SRB1). Furthermore, the method includes transmitting a message 5 (MSG5) on the SRB1 to the RAN node for reconnecting the RRC connection.

The proposed method and system can be used to define the resume procedure in NR for state transition from RRC inactive state to RRC idle state. The proposed method and system is also applicable to define the reestablishment procedure in NR for reestablishing the RRC connection when one of the trigger conditions is experienced in RRC connected state. Further the proposed method and system also mitigate a DoS attack on a UE due to replay attack in a RRC inactive state. The UE and an eNB includes a freshness parameter (i.e., a Nonce or a wait time interval value) in the ShortResumeMAC-I calculation, so that an attacker cannot perform replay attack on the UE. The proposed method can be used to mitigate the replay attack on the UE in inactive state using the Nonce. Alternately, the method can be also used to mitigate the replay attack on the UE in inactive state using the wait time interval value. The proposed method and system is not only applicable to NR system but also the RRC inactive state when LTE eNB is connected to 5G core network.

In various embodiments, the method includes reconnecting a RRC connection of a UE by a RAN node, in a wireless communication system. The method includes receiving a request message from the UE with a set of connection parameters for reconnecting the RRC connection. The method includes identifying a stored context of the UE and verifying the UE which sent the request. Further, the method includes transmitting a response message on SRB1 to the UE in response to identifying and verifying the stored UE context. Furthermore, the method includes transmitting a RRC message to the UE on signaling radio bearer 0 (SRB0) upon determining either the stored UE context cannot be retrieved or RAN congestion condition.

Referring now to the drawings, and more particularly to FIGS. 3 through 16, where similar reference characters denote corresponding features consistently throughout the figures, there are shown preferred embodiments.

FIG. 3 is a high level overview of a NR RRC state machine with possible transitions between RRC states, according to the embodiments as disclosed herein. In 5G radio access technology (i.e. 5G RAT or NR RAT), suspend and resume of RRC connection is specified to allow a gNB to suspend an RRC connection of a UE to be resumed by the UE at a later time. In 5G RAT or NR RAT when the RRC connection of the UE is suspended the UE moves to INACTIVE state and the control plane connection and user plane connection (i.e. N2 and N3 interface between gNB and AMF/UPF) are respectively maintained. The UE and gNB store the AS security context at suspend and reactivate the AS security context at resume. The INACTIVE state is modeled as the independent RRC state, and thus the following state transition cases can be envisioned from IDLE to CONNECTED, and from CONNECTED to IDLE; from CONNECTED to INACTIVE, and from INACTIVE to CONNECTED; from INACTIVE to IDLE (in certain error scenarios of state mis-match between UE and gNB). The modelling of the IDLE, INACTIVE and the CONNECTED state with respect to the non-access stratum (NAS) states is shown in Table 1. The non-access stratum (NAS) layer will have two states: CM_IDLE and CM_CONNECTED while the access stratum (i.e. AS or RRC layer) has three states. At the NAS layer, a UE can be either in CM_IDLE or in CM_CONNECTED mode. The CM_CONNECTED mode comprises two RRC states: INACTIVE and CONNECTED.

TABLE 1
State model

| | | |
|---|---|---|
| NAS | CM_IDLE | CM_CONNECTED |

| | | | |
|---|---|---|---|
| AS (RRC) | IDLE | INACTIVE | CONNECTED |

The RRC INACTIVE state can be characterized as follows where the UE performs following operations: PLMN selection, acquisition of system information from broadcast, Cell re-selection, responding to Paging initiated by gNB (i.e. RAN paging), RAN-based notification area (RNA) update, monitoring RAN paging according to DRX configured by gNB and UE AS context is stored in gNB and the UE.

In order to mitigate the DoS attack on the UE in Suspend state, the UE and the eNB include freshness parameter in the ShortResumeMAC-I calculation, so that attacker cannot perform replay attack on the UE. MAC-I stands for message authentication code—integrity.

The challenge here is that, the freshness parameter needs to be agreed/negotiated between the UE and the eNB/gNB, for the particular security context and not to be indicated along with the RRC connection Resume Request message. If the freshness parameter is included in the RRC connection Resume Request message, then it may lead to the Man-in-the-middle attack.

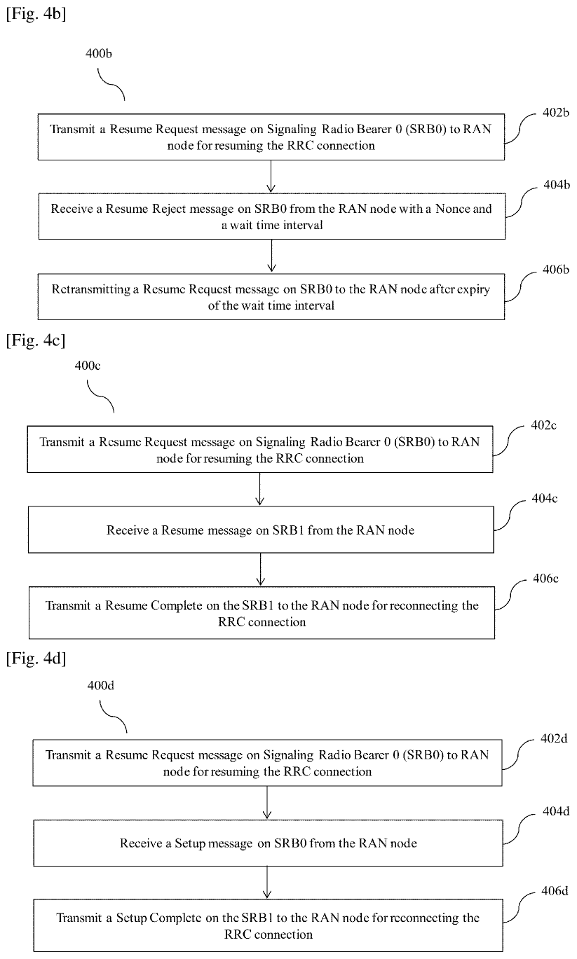

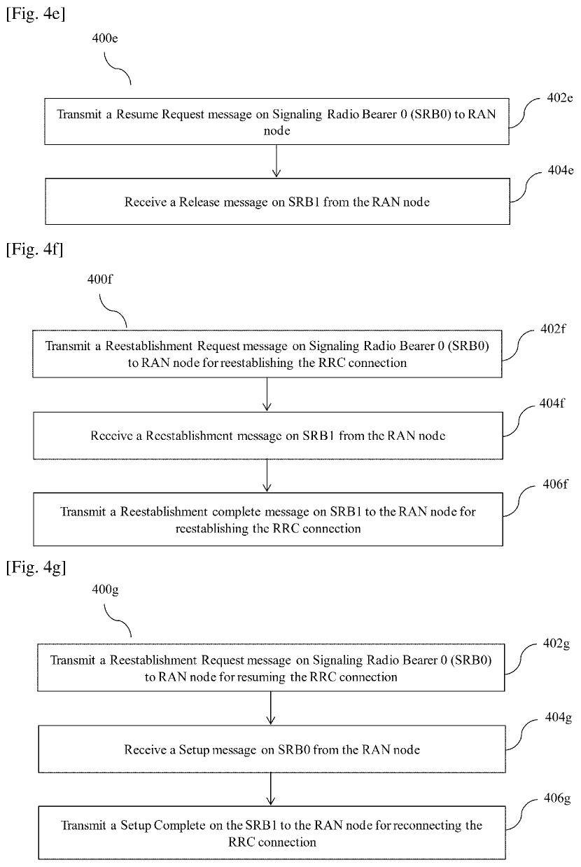

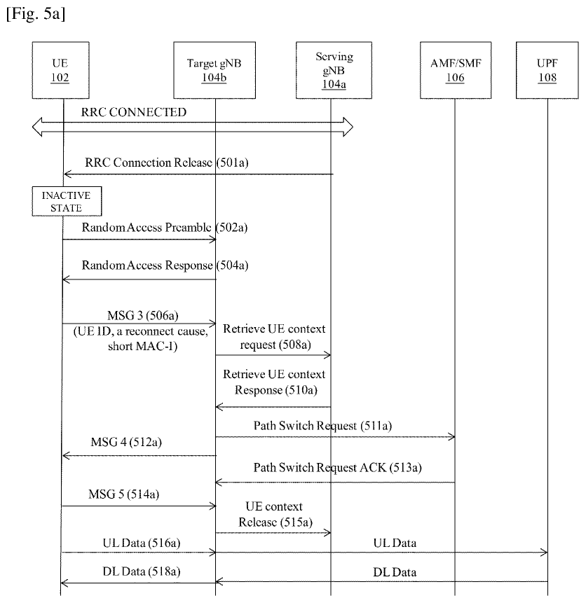

FIGS. 4A-4G are flow diagrams 400a-400g illustrating a method for reconnecting a RRC connection with a radio access network (RAN) node 104 by a user equipment (UE) 102 in a wireless communication system, according to an embodiment as disclosed herein.

FIG. 4A is a flow diagram 400a illustrating a method for reconnecting the RRC connection with the RAN node 104. At step 402a, the method includes transmitting a message 3 (MSG3) of a random access procedure on signaling radio bearer 0 (SRB0) for reconnecting the RRC connection. The UE 102 is configured to transmit the MSG3 of the random access procedure on the SRB0. The MSG 3 is a request message to the RAN node 104 with a set of connection parameters. The set of connection parameters includes a UE identifier (UE ID), a first authentication token, a reconnect cause value to reconnect the RRC connection and a next hop chaining counter (NCC). The UE 102 is configured to perform step 102a either to transition from RRC inactive state to RRC connected state or when the UE 102 experiences one of the trigger conditions for connection re-establishment.

In an embodiment, the UE ID is either the resume identifier (i.e. Resume ID) referred as implicit radio network temporary identifier (I-RNTI) or the UE ID is a combination of last serving cell allocated C-RNTI and last serving cell physical cell identifier (PCI). The UE ID is used by the RAN node for identifying the UE context at the RAN node. The UE is configured to use the UE ID as Resume ID which is set to the I-RNTI when resuming the RRC connection from inactive state. The UE is configured to use the UE ID as combination of last serving cell allocated C-RNTI and last serving cell PCI when re-establishing the RRC connection upon experiencing one of the trigger conditions for connection re-establishment.

The first authentication token is referred as ShortMAC-I, which is determined using a last serving cell allocated C-RNTI, a last serving cell physical cell identifier (PCI), and a target cell ID calculated using the RRC integrity security key of last serving cell. The target cell ID is the global cell ID of the cell on which the UE transmits the MSG3. The global cell ID of the target cell is obtained from the system information block 1 (SIB1) of the target cell. The RRC integrity security key (i.e. KRRCint) is the security key associated with the last serving cell. In case of inactive state the last serving cell refers to the cell which sent the UE to RRC inactive state from RRC connected state. In case of re-establishment the last serving cell refers to the cell where the UE experienced one of the trigger conditions for connection re-establishment.

In an embodiment, the MSG3 for reconnecting the RRC connection is a resume request message transmitted by the UE 102 to the RAN node 104 to transition from an inactive state to a connected state.

In an embodiment, the MSG3 for reconnecting the RRC connection is a reestablishment request message received from the UE 102 in the connected state by the RAN node 104 to reestablish the RRC connection.

At step 404a, the method includes receiving a message 4 (MSG4) of the random access procedure by the UE 102 from the RAN node 104. The UE 102 is configured to receive the MSG4 of the random access procedure from the RAN node 104. The MSG4 is received on either on SRB0 or SRB1.

In an embodiment, the MSG4 received on the SRB0 is either a Reject message to move the UE back to an inactive state or a Setup message to indicate the UE to fallback to an idle state. The RAN node 104 transmits the Reject message on SRB0 in response to the resume request message to move the UE 102 back to inactive state if a RAN congestion or RAN overload condition is determined. In such a case the reject message includes at least the wait timer and a Nonce. The UE 102 is configured to start the wait timer received in the reject message. The RAN node 104 transmits the Setup message on SRB0 in response to either the resume request message or the reestablishment request message upon determining the UE context cannot be retrieved. The UE 102 is configured to move to idle state, indicate to NAS layer that it is transitioning to idle state upon reception of the Setup message on SRB0.

In an embodiment, the MSG4 received on the SRB1 is a RRC message responded to the request message (i.e., Resume request message which is MSG 3) to transition the UE 102 to either a connected state or an idle state or back to inactive state. The RRC message sent on SRB1 (i.e. MSG4) is integrity protected with a new RRC integrity security key (i.e. KRRCint) and ciphered with a new RRC encryption security key (i.e. KRRCenc). The KRRCint used to integrity protect the RRC message sent on SRB1 is a new security key different from the KRRCint used to calculate the shortMAC-I sent in the request message. The new KRRCint is derived from KgNB*; wherein the KgNB* is derived either through vertical key derivation or horizontal key derivation.

In an embodiment, the RRC message (i.e. MSG4) received on SRB1 by the UE 102 from the RAN node 104 is a RRC Resume message to move the UE to connected state. The RRC resume message comprising parameters to resume the data radio bearers (DRBs) is sent by the RAN node 104 in response to the resume request message which includes at least the reconnect cause value indicating resuming the RRC connection for data exchange. In another embodiment, the RRC message (i.e. MSG4) received on SRB1 by the UE 102 from the RAN node 104 is a RRC Release message to move the UE to back to either inactive state or idle state. The RRC release message comprising at least new Resume ID or I-RNTI, new paging parameters and new NCC is sent by the RAN node 104 in response to the resume request message which includes at least the reconnect cause value indicating RAN paging area update. In another embodiment, if the RRC release message sent on SRB1 does not include a new Resume ID, new paging parameters and a new NCC, it is implicit indication to the UE to transition to RRC idle state. In yet another embodiment, the RAN node 104 transmits a RRC release message to the UE 102 on SRB1 to move the UE back to idle state in response to the resume request message; wherein the RRC release message includes an explicit indicator to release the RRC connection.

In another embodiment, the MSG4 received on the SRB1 is a reestablishment message in response to a reestablishment request message sent by the UE 102. The reestablishment message received on SRB1 is integrity protected with a new RRC integrity security key (i.e. KRRCint) and ciphered with a new RRC encryption security key (i.e. KRRCenc). The KRRCint used to integrity protect the reestablishment message sent on SRB lis a new security key different from the KRRCint used to calculate the shortMAC-I sent in the reestablishment request message. The new KRRCint is derived from KgNB*; wherein the KgNB* is derived through horizontal key derivation.

In yet another embodiment, the MSG4 received on the SRB0 is a Setup message in response to a reestablishment request message sent by the UE 102. The RAN node 104 transmits the Setup message on SRB0 in response to the reestablishment request message upon determining the UE context cannot be retrieved or the RAN node does not have KgNB* which is horizontally derived.

At step 406a, the method includes transmitting a message 5 (MSG5) on the SRB1 to the RAN node 104 for reconnecting the RRC connection. The UE 102 is configured to transmit the MSG5 on the SRB1 to the RAN node 104 for reconnecting the RRC connection. At step 406a, if the MSG4 received at step 404a is resume message on SRB1 the MSG5 is resume complete message to transition to connected state. At step 406a, if the MSG4 received at step 404a is reestablishment message on SRB1 the MSG5 is reestablishment complete message to complete the reestablishment procedure. If the MSG4 received at step 404a is release message on SRB1 indicating the UE to move back to inactive state or transition to idle state the MSG5 at step 406a is not transmitted by the UE 102. If the MSG4 received at step 404a is reject message on SRB0 indicating the UE to move back to inactive state the MSG5 at step 406a is not transmitted by the UE 102 but the UE 102 starts the wait timer received in the reject message. If the MSG4 received at step 404a is Setup message on SRB0 indicating the UE to fallback to idle state the UE transitions to idle state and informs the NAS layer. Upon receiving the indication from RRC layer about transitioning to RRC idle state the NAS layer transitions from CM_CONNECTED to CM_IDLE and triggers the transmission of either service request or TAU request or Attach request which is transported as NAS PDU in MSG5. At step 406a MSG5 is Setup complete message transmitted on SRB1 by the UE 102. The setup complete message is only integrity protected but not ciphered.

The various actions, acts, blocks, steps, or the like in the flow chart 400a may be performed in the order presented, in a different order or simultaneously. Further, in some embodiments, some of the actions, acts, blocks, steps, or the like may be omitted, added, modified, skipped, or the like without departing from the scope of the invention.

FIG. 4B is a flow diagram 400b illustrating a method in which the UE 102 retransmits a resume request message for resuming the RRC connection with the RAN node, according to an embodiment as disclosed herein. At step 402b, the method includes transmitting a Resume Request message on signaling radio bearer 0 (SRB0) to the RAN node 104 for resuming the RRC connection. The UE 102 is configured to transmit the Resume Request message on SRB0 to the RAN node 104 for resuming the RRC connection. The resume request message is transmitted to the RAN node 104 to either transition from an inactive state to a connected state or to perform RAN paging area update. The reconnect cause value included in the resume request message indicates whether the UE 102 intends to transition to connected state for data exchange with the RAN node 104 or the UE 102 intends to perform RAN paging area update with the RAN node 104. The resume request message includes the Resume ID, the first authentication token and a reconnect cause value. The first authentication token is determined using the last serving cell allocated C-RNTI, the last serving cell physical cell identifier (PCI) and the target cell ID calculated using the RRC integrity security key of last serving cell. The calculated first authentication token is shortened to 16 bits and referred as ShortMAC-I which is then transmitted in the resume request message.

At step 404b, the method includes receiving a Resume Reject message on SRB0 from the RAN node 104 with a Nonce and a wait time interval. The UE 102 is configured to receive the Resume Reject message on SRB0 from the RAN node 104 with a Nonce and a wait time interval. The UE 102 moves back to an inactive state in response to receiving the Resume Reject message on SRB0 and start the wait timer received in the reject message at step 404b. The AS context stored by the UE 102 remains unchanged upon reception of the reject message at step 404b.

At step 406b, the method includes retransmitting a Resume Request message on SRB0 to the RAN node 104 after the expiry of the wait time interval. The UE 102 is configured to retransmit the Resume Request message on SRB0 to the RAN node 104 after expiry of the wait time interval. In an embodiment, the retransmitted resume request includes the UE ID, the second authentication token, and a reconnect cause value. The second authentication token is determined using the last serving cell allocated C-RNTI, the last serving cell physical cell identifier (PCI), the target cell ID and either of a Nonce or a wait time interval value calculated using the RRC integrity security key of last serving cell. The calculated second authentication token is shortened to 16 bits and referred as ShortMAC-I which is then transmitted in the resume request message. The Nonce or wait time interval value is used in the calculation of second authentication token as a freshness parameter only if the target Cell ID on which the resume request re-transmission attempt at step 406b is same as the initial resume request attempt at step 402b. If the target Cell ID in the resume request attempt at step 402b is different from the retransmit resume request attempt at step 406b then the Nonce or wait time interval value is not used in the calculation of second authentication token. This is because the different target Cell ID used in the authentication token calculation acts the required freshness parameter.

The various actions, acts, blocks, steps, or the like in the flow chart 400b may be performed in the order presented, in a different order or simultaneously. Further, in some embodiments, some of the actions, acts, blocks, steps, or the like may be omitted, added, modified, skipped, or the like without departing from the scope of the invention.

FIG. 4C is a flow diagram 400c illustrating method for resuming the RRC connection with the RAN node, according to an embodiment as disclosed herein. At step 402c, the method includes transmitting a resume request message on SRB0 to the RAN node 104 for resuming the RRC connection. The UE 102 is configured to transmit the resume request message on SRB0 to the RAN node 104 for resuming the RRC connection. The resume request message is transmitted to the RAN node 104 to transition from an inactive state to a connected state. The resume request message sent on SRB0 to the RAN node 104 includes a set of connection parameters. The set of connection parameters includes a UE identifier (UE ID) which is the Resume ID, a first authentication token which is the shortMAC-I and a reconnect cause value to reconnect the RRC connection for data exchange or to perform RAN paging area update. The Resume ID included in resume request message is the Resume ID provided to the UE by the last serving cell which sent the UE from connected state to inactive state. The first authentication token is determined using the last serving cell allocated C-RNTI, the last serving cell Physical Cell Identifier (PCI) and the target cell ID calculated using the RRC integrity security key of last serving cell (i.e. KRRCint). The calculated first authentication token is shortened to 16 bits and referred as ShortMAC-I which is then transmitted in the resume request message.

At step 404c, the method includes receiving a resume message on SRB1 from the RAN node 104. The UE 102 is configured to receive the resume message on SRB1 from the RAN node 104. The resume message received on the SRB1 is to transition the UE 102 to a connected state. The resume message is integrity protected with a new RRC integrity security key (i.e. KRRCint) and ciphered with a new RRC encryption security key (i.e. KRRCenc).

In an embodiment, the new RRC integrity security key and new RRC encryption key used for security protection of resume message is derived using a vertical key derivation or a horizontal key derivation. The details of the vertical key derivation and the horizontal key derivation are explained in conjunction with the FIG. 5A. The KRRCint used to integrity protect the resume message is a new KRRCint different from the KRRCint used to calculate the shortMAC-I sent in the request message. The new KRRCint is derived from KgNB*; wherein the KgNB* is derived either through vertical key derivation or horizontal key derivation. The UE 102 derives the KgNB* based on the NCC value provided to the UE by the last serving cell which sent the UE from connected state to inactive state. The UE 102 further derives the new KRRCint and new KRRCenc from the derived KgNB* to receive the resume message sent on SRB1. The resume message includes the parameters to resume the data radio bearers (DRBs). The RAN node transmits the resume message at step 404c upon identifying, verifying the stored UE context and retrieving the stored UE context from the last serving cell which sent the UE from connected state to inactive state. The details of UE context retrieval is explained in details in FIG. 5A.

At step 406c, the method includes transmitting the resume complete message on the SRB1 to the RAN node 104 for reconnecting the RRC connection. The UE 102 is configured to transmit the resume complete message on the SRB1 to the RAN node 104 for reconnecting the RRC connection. The resume complete message is protected by the new RRC integrity security key and new RRC encryption key used by the UE 102 to receive the resume message. The various actions, acts, blocks, steps, or the like in the flow chart 400c may be performed in the order presented, in a different order or simultaneously. Further, in some embodiments, some of the actions, acts, blocks, steps, or the like may be omitted, added, modified, skipped, or the like without departing from the scope of the invention.

FIG. 4D is a flow diagram 400d illustrating a method for reconnecting a RRC connection with the RAN node 104, according to an embodiment as disclosed herein.

At step 402d, the method includes transmitting a resume request message on SRB0 to the RAN node 104 for resuming the RRC connection. The UE 102 is configured to transmit Resume Request message on SRB0 to RAN node 104 for resuming the RRC connection. The resume request message sent on SRB0 to the RAN node 104 includes a set of connection parameters. The set of connection parameters includes a UE Identifier (UE ID) which is the Resume ID, a first authentication token which is the shortMAC-I and a reconnect cause value to reconnect the RRC connection for data exchange or to perform RAN paging area update. The Resume ID included in resume request message is the Resume ID provided to the UE by the last serving cell which sent the UE from connected state to inactive state. The first authentication token is determined using the last serving cell allocated C-RNTI, the last serving cell Physical Cell Identifier (PCI) and the target cell ID calculated using the RRC integrity security key of last serving cell (i.e. KRRCint). The calculated first authentication token is shortened to 16 bits and referred as ShortMAC-I which is then transmitted in the resume request message.

At step 404d, the method includes receiving a Setup message on SRB0 from the RAN node 104. The UE 102 is configured to receive the Setup message on SRB0 from the RAN node 104. The Setup message received from the RAN node 104 indicates the UE 102 to fallback to an idle state. The RAN node transmits the setup message at step 404d upon determining that the UE stored context cannot be retrieved. The details of UE context retrieval is explained in FIG. 5A. Upon receiving the fallback indication, the UE 102 does not have to start a new random access (i.e RACH) procedure. The UE 102 informs to NAS layer about fallback, discards the stored UE context, releases the resume ID. The NAS layer on receiving fallback indication sends NAS PDU (i.e., service request/attach request) to AS layer i.e. RRC layer.

At step 404d a Setup message on SRB0 indicating the UE to fallback to idle state is received. The UE transitions to idle state and informs the NAS layer. Upon receiving the indication from RRC layer about transitioning to RRC idle state the NAS layer transitions from CM_CONNECTED to CM_IDLE and triggers the transmission of either service request or TAU request or Attach request which is transported as NAS PDU in Setup complete message. At step 406d the Setup complete message is transmitted on SRB1 by the UE 102. The UE 102 is configured to transmit the setup complete message on SRB1. The setup complete message is only integrity protected but not ciphered

The various actions, acts, blocks, steps, or the like in the flow chart 400d may be performed in the order presented, in a different order or simultaneously. Further, in some embodiments, some of the actions, acts, blocks, steps, or the like may be omitted, added, modified, skipped, or the like without departing from the scope of the invention.

FIG. 4E is a flow diagram 400e illustrating a method in which the UE 102 receives a release message on SRB1 from the RAN node 104, according to an embodiment as disclosed herein.

At step 402e, the method includes transmitting a resume request message on SRB0 to the RAN node 104 for performing RAN paging area update. The UE 102 is configured to transmit Resume Request message on SRB0 to RAN node 104 for performing RAN paging area update. The resume request message sent on SRB0 to the RAN node 104 includes a set of connection parameters. The set of connection parameters includes a UE identifier (UE ID) which is the Resume ID, a first authentication token which is the shortMAC-I and a reconnect cause value to perform RAN paging area update. The Resume ID included in resume request message is the Resume ID provided to the UE by the last serving cell which sent the UE from connected state to inactive state. The first authentication token is determined using the last serving cell allocated C-RNTI, the last serving cell physical cell identifier (PCI) and the target cell ID calculated using the RRC integrity security key of last serving cell (i.e. KRRCint). The calculated first authentication token is shortened to 16 bits and referred as ShortMAC-I which is then transmitted in the resume request message.

At step 404e, the method includes receiving a release message on SRB1 from the RAN node 104. The UE 102 is configured to receive the release message on SRB1 from the RAN node 104. The release message received on the SRB1 is to transition the UE 102 to either the idle state or move back the UE to inactive state. The release message is integrity protected with a new RRC integrity security key (i.e. KRRCint) and ciphered with a new RRC encryption security key (i.e. KRRCenc).

In an embodiment, the new RRC integrity security key and new RRC encryption key used for security protection of release message is derived using a vertical key derivation or a horizontal key derivation. The details of the vertical key derivation and the horizontal key derivation are explained in conjunction with the FIG. 5A. The KRRCint used to integrity protect the release message is a new KRRCint different from the KRRCint used to calculate the shortMAC-I sent in the resume request message. The new KRRCint is derived from KgNB*; wherein the KgNB* is derived either through vertical key derivation or horizontal key derivation. The UE 102 derives the KgNB* based on the NCC value provided to the UE by the last serving cell which sent the UE from connected state to inactive state. The UE 102 further derives the new KRRCint and new KRRCenc from the derived KgNB* to receive the release message sent on SRB1. The RAN node transmits the release message at step 404e upon identifying, verifying the stored UE context and retrieving the stored UE context from the last serving cell which sent the UE from connected state to inactive state. The details of UE context retrieval is explained in details in FIG. 5A. The release message includes the parameters to update the UE context when the UE is sent back to inactive state. The RRC release message sent on SRB1 to move UE back to RRC inactive state includes at least a new Resume ID i.e. I-RNTI, new paging parameters and a new NCC. In another embodiment, if the RRC release message sent on SRB1 does not include a new Resume ID, new paging parameters and a new NCC, it is implicit indication to the UE to transition to RRC idle state.

In an embodiment, the RAN node transmits a RRC release message to the UE on SRB1 to move the UE back to idle state in response to the resume request message; wherein the RRC release message includes an explicit indicator to release the RRC connection. The reception of the release message on SRB1 with either implicit or explicit indication to move the UE to RRC idle state is independent of the reconnect cause value included in the resume request message.

FIG. 4F is a flow diagram 400f illustrating a method in which the UE 102 receives a reestablishment message on SRB1 for reestablishing the RRC connection with the RAN node 104, according to an embodiment as disclosed herein.

At step 402f, the method includes transmitting a Reestablishment Request message on SRB0 to the RAN node 104 for reestablishing the RRC connection. The UE 102 is configured to transmit the Reestablishment Request message on SRB0 to the RAN node 104 for reestablishing the RRC connection. The reestablishment request message sent on SRB0 to the RAN node 104 includes a set of connection parameters. The set of connection parameters includes a UE Identifier (UE ID), a first authentication token which is the shortMAC-I, a reconnect cause value and the NCC. The UE ID included in the reestablishment request message is combination of last serving cell allocated C-RNTI and last serving cell PCI. The first authentication token is determined using the last serving cell allocated C-RNTI, the last serving cell Physical Cell Identifier (PCI) and the target cell ID calculated using the RRC integrity security key of last serving cell (i.e. KRRCint). The calculated first authentication token is shortened to 16 bits and referred as ShortMAC-I which is then transmitted in the reestablishment request message. The NCC included in the reestablishment request message is the NCC available with the UE when reestablishment condition was triggered.

At step 404f, the method includes receiving the Reestablishment message on SRB1 from the RAN node 104. The UE 102 is configured to receive the Reestablishment message on SRB1 from the RAN node 104. The reestablishment message received on the SRB1 is integrity protected with a new RRC integrity security key and ciphered with a new RRC encryption security key. In an embodiment, the new RRC integrity security key and new RRC encryption key used for security protection of reestablishment message is derived using horizontal key derivation. The KRRCint used to integrity protect the reestablishment message is a new KRRCint different from the KRRCint used to calculate the shortMAC-I sent in the reestablishment request message. The new KRRCint is derived from KgNB*; wherein the KgNB* is derived through horizontal key derivation. The UE 102 derives the KgNB* based on the current NCC value available with the UE when the reestablishment condition was triggered. The UE 102 further derives the new KRRCint and new KRRCenc from the derived KgNB* to receive the reestablishment message sent on SRB1. The RAN node transmits the reestablishment message at step 404f upon identifying, verifying the stored UE context and retrieving the stored UE context from the last serving cell where the UE context was stored. The RAN node transmits the reestablishment message at step 404f on SRB1 if KgNB* which is horizontally derived is available with the RAN node 104. The details about horizontal key derivation are explained in conjunction with FIG. 5B. The security key can be refreshed for all re-establishment trigger conditions with the transmission of re-establishment request message (i.e. MSG 3) without waiting for receiving the NCC in the re-establishment message (i.e. MSG 4) like in LTE. This can be accomplished based on horizontal key derivation where the UE updates the security key using the active security key depending on the trigger condition as follows:

New key (KgNB*)=KDF[KgNB_source_PCell, (PCI, 5G-ARFCN-DL) of re-establish_attempt_cell] for HO failure or mobility from NR failure

New key (KgNB*)=KDF [KgNB_current_PCell, (PCI, 5G-ARFCN-DL) of re-establish_attempt_cell] for RLF failure, IP Check failure or Re-configuration failure

After the UE is verified by the RAN node 104 the new key is used by the re-establish attempt cell to protect reestablishment message i.e. MSG4. There is no need to include NCC in reestablishment message i.e MSG4 since the UE has already updated the security key. It should then also be possible to resume SRB2 and DRB(s) similar to resume procedure.

In an embodiment, the new security key i.e. KRRCint and KRRCenc to protect reestablishment message sent for all re-establishment trigger conditions is based on horizontal key derivation.

In an embodiment, after UE verification, the new key is used to protect re-establishment message i.e. MSG4 and there is no need to include NCC in MSG4.

In an embodiment, SRB(s) and DRB(s) can be resumed for all re-establishment trigger conditions.

At step 406f, the method includes transmitting a Reestablishment complete message to the RAN node 104 for reestablishing the RRC connection. The UE 102 is configured to transmit the Reestablishment complete message to the RAN node 104 for reestablishing the RRC connection.

The various actions, acts, blocks, steps, or the like in the flow chart 400f may be performed in the order presented, in a different order or simultaneously. Further, in some embodiments, some of the actions, acts, blocks, steps, or the like may be omitted, added, modified, skipped, or the like without departing from the scope of the invention.

FIG. 4G is a flow diagram 400g illustrating a method in which the UE 102 receives a Setup message on SRB0 for reestablishing the RRC connection with the RAN node 104, according to an embodiment as disclosed herein.

At step 402g, the method includes transmitting a Reestablishment Request message on SRB0 to the RAN node 104 for reestablishing the RRC connection. The UE 102 is configured to transmit the Reestablishment Request message on SRB0 to the RAN node 104 for reestablishing the RRC connection. The reestablishment request message sent on SRB0 to the RAN node 104 includes a set of connection parameters. The set of connection parameters includes a UE Identifier (UE ID), a first authentication token which is the shortMAC-I, a reconnect cause value and the NCC. The UE ID included in the reestablishment request message is combination of last serving cell allocated C-RNTI and last serving cell PCI. The first authentication token is determined using the last serving cell allocated C-RNTI, the last serving cell Physical Cell Identifier (PCI) and the target cell ID calculated using the RRC integrity security key of last serving cell (i.e. KRRCint). The calculated first authentication token is shortened to 16 bits and referred as ShortMAC-I which is then transmitted in the reestablishment request message. The NCC included in the reestablishment request message is the NCC available with the UE when reestablishment condition was triggered. The RAN node 104 can determine whether the [KgNB*, NCC] pair received either during the Xn handover procedure or during the Xn context fetch procedure, the received KgNB* is either horizontally derived or vertically derived based on comparison of the NCC received in the Xn procedure and the NCC received from the UE in the reestablishment request message. If the NCC comparison matches the RAN node 104 determines the KgNB* is horizontally derived. If the NCC comparison does not match the RAN node 104 determines the KgNB* is vertically derived.

At step 404g, the method includes receiving the Setup message on SRB0 from the RAN node 104. The UE 102 is configured to receive the Setup message on SRB0 from the RAN node 104. The Setup message received on the SRB0 is neither integrity protected nor ciphered. The RAN node transmits the Setup at step 404g upon either failing to retrieve the stored UE context from the last serving cell where the UE context was stored or upon determining the KgNB* received in the Xn procedure is vertically derived. The RAN node transmits the Setup message at step 404g on SRB0 if KgNB* received in Xn procedure is vertically derived. The details about key handling during Xn procedure is explained in conjunction with FIG. 5B. The Setup message received from the RAN node 104 indicates the UE 102 to fallback to an idle state. The RAN node transmits the setup message at step 404g upon determining that the UE stored context cannot be retrieved. Upon receiving the fallback indication, the UE 102 does not have to start a new random access (i.e RACH) procedure. The UE 102 informs to NAS layer about fallback, discards the stored UE context, and releases the resume ID. The NAS layer on receiving fallback indication sends NAS PDU (i.e., service request/attach request) to AS layer i.e. RRC layer.

At step 404g a Setup message on SRB0 indicating the UE to fallback to idle state is received. The UE transitions to idle state and informs the NAS layer. Upon receiving the indication from RRC layer about transitioning to RRC idle state the NAS layer transitions from CM_CONNECTED to CM_IDLE and triggers the transmission of either service request or TAU request or Attach request which is transported as NAS PDU in Setup complete message. At step 406g the Setup complete message is transmitted on SRB1 by the UE 102. The UE 102 is configured to transmit the setup complete message on SRB1. The setup complete message is only integrity protected but not ciphered

The various actions, acts, blocks, steps, or the like in the flow chart 400g may be performed in the order presented, in a different order or simultaneously. Further, in some embodiments, some of the actions, acts, blocks, steps, or the like may be omitted, added, modified, skipped, or the like without departing from the scope of the invention.

FIG. 5A is a sequence diagram in which the UE 102 sends a connection resume request message for resuming the RRC connection with the RAN node 104, according to an embodiment as disclosed herein.

The UE 102 is in RRC connected state served by a serving cell handled by Serving or Source gNB 104a. After the data exchange between UE 102 and Serving gNB 104b, the UE 102 is sent to inactive state with the transmission of RRC release message (501a). The UE is provided with Resume ID, RAN paging parameters and a NCC in the release message (501a) which is implicit indication to move to inactive state. If not provided or if explicit indictor included for releasing the RRC connection then the UE 102 moves to idle state. In order to establish a security context (especially a key), a count value (n-hop forward security) and a next-hop chaining count (NCC) is received in a RRC connection release message (501a) from a serving gNB 104a. Upon transition to inactive state the UE 102 stores the AS security context, the received Resume ID i.e. I-RNTI, the received NCC and a count if provided. The serving gNB 104a stores the UE context and the N2/N3 connection of the UE with AMF/SMF and UPF is maintained.

The UE 102 transmits (502a) a random access preamble to a target gNB 104b if any resume trigger condition is determined i.e. UL data or paging for DL data or RAN area paging update. In response to the random access preamble, the UE 102 receives (504a) a random access response (RAR) message from the target gNB 104b.

Further, the UE 102 sends (506a) a connection resume request message (i.e. MSG3) on SRB0, including the Short MAC-I (or MAC-I i.e. authentication token) calculated based on existing key i.e. KRRCint associated with the last serving gNB 104a. The connection Resume request message (MSG3) is sent on SRB0 is neither integrity protected nor encrypted. The UE 102 may derive new key using NCC and counter received in the release message, old key (KeNB) and may also using other possible parameters. However, if any UL data is sent along with MSG3 then the UL data may be encrypted with the new derived key. Alternately, any UL data sent along with MSG3, the UL data may be encrypted with the old security key i.e. KUPenc associated with the last serving gNB 104a.

Further, upon reception of the resume request message (506a) the target gNB 104b transmits (508a) a request for retrieving the UE context on the Xn interface. The target gNB 104b identifies the Serving gNB 104a to retrieve the UE context based on the Resume ID included in the resume request message (506a). The target gNB 104b can decompose the Resume ID into UE ID part and gNB ID part. Upon determining the gNB ID part the target gNB 104b identifies the serving gNB 104a as the last serving gNB where the UE context may be stored. The retrieve UE context request message (508a) includes at least the Resume ID, the shortMAC-I, the PCI of the serving cell of the target gNB 104b, the associated the NR DL-ARFCN and the target Cell ID.

The serving gNB 104a identifies the stored UE context based on the Resume ID included the retrieve UE context request message (508a). If the UE context is identified then the serving gNB 104a is required to verify the UE 102 which sent the resume request message (506a). Based on the identified UE context the serving gNB determines the C-RNTI allocated to the UE 102 and the PCI of the last serving cell. The serving gNB 104a calculates the authentication token based on the C-RNTI, PCI and target Cell ID using the last serving integrity protection security key i.e. KRRCint. The generated authentication token is shortened to 16 bits to get the shortMAC-I and compared with the shortMAC-I received in the retrieve UE context request message (508a). If the shortMAC-I comparison matches the UE 102 is considered authentic and verified by the serving gNB 104a. In response to the request, the serving gNB 104a transmits (510a) the Retrieve UE context response to the target gNB 104b upon identifying and verifying the stored UE context. Upon successful identification and verification the serving gNB 104a transfers the UE context to target gNB 104b with the Retrieve UE context response message (510a). The serving gNB 104a derives a new AS security key KgNB* based on the NCC provided to the UE in the RRC release message (501a). The KgNB* is either vertically derived if the NCC provided to the UE is from an unused {NH, NCC] pair else the KgNB* is horizontally derived. The [KgNB*, NCC] is provided to the target gNB 104a along with the UE context in the Retrieve UE context response message (510a).

In an embodiment, the serving gNB 104a provides an explicit indicator along with [KgNB*, NCC] to the target gNB 104b to indicate whether the KgNB* is vertically derived or horizontally derived. For e.g. the indicator may be set to “1” or “TRUE” to indicate the KgNB* is vertically derived else the indictor may be set to “0” or “FALSE” to indicate the KgNB* is horizontally derived. The indicator may be optionally included in the Retrieve UE context response message (510a). If present then the KgNB* is vertically derived and if absent then KgNB* is horizontally derived.

The UE 102 receives (512a) a connection resume message (MSG4) on SRB1 from the target gNB 104b if the UE context is successful retrieved; else the target gNB 104b sends the setup message (MSG4) on SRB0. The received connection resume message (512a) is encrypted and integrity protected using the new key i.e. KgNB* received from the UE context fetch procedure. The UE 102 decrypts the MSG4 using a new derived key KgNB* based on the NCC received in the RRC release message (501a).

The UE 102 responds with MSG5 (514a) on SRB1 which is either resume complete message if the MSG4 (512a) is resume message on SRB1 else with setup complete message if the MSG4 (512a) is setup message on SRB0. The setup complete message is only integrity protected but not ciphered.

The target gNB 104b initiates the path switch request (511a) towards the AMF 106 so that N2/N3 connection with the serving gNB 104a is removed and established with the target gNB 104a. Upon receiving the path switch request ACK (513a) the N2/N3 connection is established with the target gNB 104b. The target gNB 104b receives a new [NH, NCC] pair from the AMF 106 in the path switch request ACK (513a). This unused [NH, NCC] pair can be used by the target gNB 104a to break the key chaining i.e. ensuring n-hop forward security wherein any further key refresh is based on vertical key derivation. The target gNB 104b initiates the UE context release (515a) towards the serving gNB 104a upon reception of the path switch request ACK (513a) from the AMF (106). The serving gNB 104a deletes the UE context associated with UE 102 upon reception of the UE context release (515a) from the target gNB 104b.

The resume request (506a) can be initiated for RAN paging area update wherein the reconnect cause value included in MSG3 indicates RAN paging area update. The target gNB 104b performs the context retrieval or context fetch procedure on Xn i.e. (508a) and (510a) with the serving gNB 104a. However, the target gNB 104b needs to wait for the path switch procedure i.e. (511a) and (513a) with the AMF 106 to be completed. This is because the MSG4 (512a) sent on SRB1 is a release message which should include the new NCC apart from the new Resume ID and new RAN paging parameters. The target gNB 104b receives the new [NH, NCC] pair from the AMF 106 in the path switch request ACK (513a). With the new [NH, NCC] pair the target gNB 104b can enforce n-hop forward security by breaking the key chaining. However, always waiting for the path switch can be avoided if the retrieve UE context response (510a) indicates whether the KgNB* is horizontally derived or vertically derived. If the target gNB 104b is aware whether the KgNB* provided by the serving gNB 104a is either horizontally derived or vertically derived the target gNB 104b can decide whether it needs to wait for path switch in case the resume request (506a) indicates RAN paging area update. If the KgNB* is vertically derived then the target gNB 104b does not need to wait for the path switch and can provide the same NCC which was received from the serving gNB 104a to the UE in the release message (512a). The consequence is that the UE performs horizontal key derivation for the next resume attempt which would be the 1^{st} hop for the forward security. However, if the KgNB* is horizontally derived then the target gNB 104b needs to wait for the path switch and can provide the new NCC which it will receive from the AMF 106 in (513a) to be provided to the UE in the release message (512a).

In an embodiment, signaling a count value i.e. NCC is provided by the serving gNB 104b in a RRC connection release message. The UE storing this information and using it for deriving further new key(s) i.e. KRRCint, KRRCenc, KUPint and KUPenc for integrity protection of data/signaling in INACTIVE state and to use it for encrypting/decrypting data/signaling in subsequent connected state, irrespective of whether UE is in same cell or not.

In an embodiment, some security information is signaled by the serving gNB 104b in the RRC connection release message. The UE storing this security information and using it for deriving further new key(s) for integrity protection of data/signaling in INACTIVE state and to use it for encrypting/decrypting data/signaling in subsequent connected state, irrespective of whether UE is in same cell or not.

In an embodiment, the signaled security information by the serving gNB 104a in the RRC connection release message can be counter and/or nexthopchainingcount (NCC) and/or an indicator to refresh key. The UE storing this security information and using it for deriving further new key(s) for integrity protection of data/signaling in INACTIVE state and to use it for encrypting/decrypting data/signaling in subsequent connected state, irrespective of whether UE is in same cell or not.

In another embodiment, if UE is in same gNB (or cell) in which it has entered INACTIVE state, then the UE uses the existing key. If the UE moves to a different gNB (i.e., different cell) then the gNB in which it has entered INACTIVE state, the UE 102 uses counter as an index to identify the primary/root key to derive further new key(s) for integrity protection of data/signaling in INACTIVE state and to use it for encrypting/decrypting data/signaling in subsequent connected state.

In an another embodiment, a Counter value may be received along with other possible parameters in the RRC connection release message, then the UE enters to INACTIVE state; the UE stores the existing key (key used when in RRC connected state). UE sends Connection resume request i.e. MSG3 on SRB0. The Connection resume request is not encrypted and Short MAC-I included in MSG3 is generated based on the existing key i.e., the integrity security key associated with last serving gNB.

Case 1: The UE 102 is in same cell in which it entered INACTIVE state.

The UE 102 receives a connection resume message (i.e. MSG4) from the target gNB 104b. The Connection resume message is encrypted and integrity protected using existing key (i.e., the MSG4 is received on SRB1).

The UE 102 decrypts and validates (checks) the integrity protection connection resume message using existing key. Further, the UE 102 enters connected state and continues to use existing key.

Case 2: UE is in a cell different from cell in which it entered INACTIVE state

The UE 102 receives the connection resume message (i.e. MSG4) from the target gNB 104b. Connection resume message is encrypted and integrity protected using new key; i.e. MSG4 is received on SRB1.

The UE 102 derives new key i.e. KgNB* using existing key and other possible parameters based on the NCC received in the release message (501);

The UE 102 decrypts and validates connection resume message using new key i.e. new KRRCint and new KRRCenc derived from the KgNB*.

The UE 102 enters connected and continue to use new key.

In another embodiment, each time the UE enters INACTIVE state the UE 102 may receive a counter/NCC and the UE 102 may use the counter/NCC for key derivation in the INACTIVE state.

In yet another embodiment, a signaling a count value/Counter by the target gNB 104b in RRC connection resume message i.e., MSG4. The UE 102 storing this information and using it for deriving further new key(s) for integrity protection of data/signaling in INACTIVE state and to use it for encrypting/decrypting data/signaling in subsequent connected state, irrespective of whether UE 102 is in same cell or not.

In an another embodiment, the Counter received in connection release message or MSG4, PCI of the camped cell, 5G NR Absolute Radio Frequency Channel Number-Down Link (5G-ARFCN-DL) of the camped cell and other possible inputs are used to derive the new key, when the UE 102 is INACTIVE state.

TABLE 2
New key (KgNB*) = KDF(old/existing (currently active) key (KgNB),
PCI, 5G-ARFCN-DL, Count)

The above derivation is horizontal key derivation which involves the existing/old KgNB.

In yet another embodiment, the Counter received in connection release message or resume message i.e. MSG4, and other possible inputs are used to derive the new key, when the UE 102 is INACTIVE state.

TABLE 3
New key (KgNB*) = KDF(old/existing (currently active) key (KgNB),
Count)

The above derivation is horizontal key derivation which involves the existing/old KgNB.

In an another embodiment, the UE 102 is INACTIVE state uses PCI of the camped cell, 5G-ARFCN-DL of the camped cell and other possible inputs to derive the new key, when counter is not sent in release message but key change indicator is sent in release message.

TABLE 4
New key (KgNB*) = KDF (old/existing (currently active) key (KgNB),
PCI, 5G-ARFCN-DL)

The above derivation is horizontal key derivation which involves the existing/old KgNB.

In an another embodiment, the UE 102 is INACTIVE state uses PCI of the camped cell, 5G-ARFCN-DL of the camped cell and other possible inputs to derive the new key, when NCC is sent in release message and the NCC stored in UE 102 and received in release message is same.

TABLE 5
New key (KgNB*) = KDF (old/existing (currently active) key (KgNB),
PCI, 5G-ARFCN-DL)

The above derivation is horizontal key derivation which involves the existing/old KgNB.

In an another embodiment, the UE 102 is INACTIVE state uses PCI of the camped cell, 5G-ARFCN-DL of the camped cell and other possible inputs to derive the new key, when NCC is sent in release message and the NCC stored in UE and received in release message is not same (i.e. NCC received in release message is higher value compared to NCC stored in UE).

TABLE 6

New key (KgNB*) = KDF(NH, PCI, 5G-ARFCN-DL)

The above derivation is vertical key derivation which involves the NH and not the existing/old KgNB.

In another embodiment, the key is refreshed at every state transition even if there is no security information included in release message; wherein the new key is derived based on horizontal key derivation such that the input parameters to KDF is old/existing active key, PCI of cell on which resume request will be sent and 5G-ARFCN-DL of the cell.

In an embodiment, the count value received in the connection release message, limit the number of horizontal key derivation using the KgNB (to limit the KgNB chaining or ensure n-hop forward security). As there needs to be an accountability parameter to limit the horizontal key derivation, the network (gNB) maintains a counter per UE. Whenever gNB receives KgNB from Core Network, it will reset counter. It is incremented by one when UE enters INACTIVE from connected. Vertical key derivation and KeNB Rekeying happens either for Count wrap-arounds or for a defined particular value (say count>5 i.e. n>5 ensure 5-hop forward security).

When the eNB/gNB 104 determines that counter for number of horizontal key derivation attempts is about to wrap around then the vertical key derivation is enforced by releasing the UE 102 to IDLE state.

In another embodiment, even if the counter for number of horizontal key derivation attempts is not about to wrap around but the cell on which the resume request is sent, the cell has [NH, NCC] pair, then the resume message (MSG4) can include the NCC which enforces vertical key derivation and will reset the count.

In an embodiment, counter value (used to limit the KgNB chaining i.e. enforce n-hop forward security) is provided in RRC release message (may be along with other possible parameters like NCC) and the counter value may be used by the UE as an input parameter to derive new KgNB*.

In an embodiment, Counter (used to limit the KgNB chaining) is maintained only by network and not given to the UE. The UE always derives key using existing key, PCI and 5G-ARFCN-DL.

It should be noted that the above detailed procedure is applicable for the enhanced E-UTRAN which is connected to 5G core network.

FIG. 5B is a sequence diagram in which the UE 102 sends a reestablishment request message for reestablishing the RRC connection with the RAN node 104, according to an embodiment as disclosed herein.

The UE 102 is in RRC connected state served by a serving cell handled by Serving or Source gNB 104a. During the data exchange between UE 102 and Serving gNB 104b, due to mobility the UE 102 sends the measurement report (502b) to the serving gNB 104a so that the UE 102 is handed over to potential target gNBs for service continuity.

The serving gNB 104a upon reception of the measurement report (502b) from the UE 102 initiates the handover request (504b) on the Xn interface towards potential target gNBs. For simplicity all potential target gNBs is not depicted in FIG. 5B instead only one target gNB 104b is shown with which the HO request is initiated. The HO request (504b) includes the UE AS context, essential system information of the serving gNB and the RRM information. In addition, the HO request (504b) includes the [KgNB*, NCC] wherein the KgNB* is taken into use by the target gNB 104b when the handover the completed by the UE 102 with the target gNB 104b. The KgNB* is either vertically derived if the serving gNB 104a has an unused [NH, NCC] pair else the KgNB* is horizontally derived. The [KgNB*, NCC] is provided to the target gNB 104a along with the UE context in the HO request message (504b). Upon reception of the HO request (504b) the target gNB 104b applies the admission control to determine whether it can admit the UE 102 depending on the availability of radio resources. If admission control results in positive outcome then the target gNB 104b sends the HO request ACK (506b) to the serving gNB 104a. The serving gNB 104a may receive such HO request ACK from one or more target gNBs with which it had initiated the HO request and depending on the outcome of admission control in respective target gNB s.

The HO request ACK (506b) is a HO command which includes information on radio resources allocated by the target gNB 104b to accept the UE 102 and it also includes either the entire or delta configuration of the essential system information of the target gNB 104b. The HO request ACK also includes the NCC provided by the serving gNB 104a in the HO request (504b). The contents of the HO request ACK (506b) is transparently included in the RRC reconfiguration with syn message (508b) sent to the UE 102. However, if the Xn HO procedure is delayed then the radio conditions may degrade and the UE 102 may not be able to receive the HO command i.e. RRC reconfiguration with sync message (508b) from the serving gNB 104a in which the re-establishment condition is triggered. The UE performs cell selection to find a suitable cell to perform connection re-establishment procedure. If the UE selects the cell served by the target gNB 104b then the UE 102 transmits (510b) a random access preamble to a target gNB 104b. In response to the random access preamble, the UE 102 receives (512b) a random access response (RAR) message from the target gNB 104b.

Further, the UE 102 sends (514b) a reestablishment request message (i.e. MSG3) on SRB0, including the Short MAC-I (or MAC-I i.e. authentication token) calculated based on existing key i.e. KRRCint associated with the last serving Gnb 104a. The Reestablishment request message (MSG3) is sent on SRB0 is neither encrypted nor integrity protected. The reestablishment request message (514b) includes the UE ID which a combination of the last serving cell allocated C-RNTI and last serving cell Physical Cell Identifier (PCI) in addition to the shortMAC-I and the reconnect cause value. Further, upon reception of the Reestablishment request message (514b) the target Gnb 104b checks if the UE context is available based on the UE ID included in (514b). Since the target Gnb 104b is prepared target even though the UE context is available in the target Gnb 104b the serving Gnb 104a needs to verify the UE 102. The target Gnb 104b then transmits a request for retrieving the UE context on the Xn interface. The target Gnb 104b identifies the Serving Gnb 104a to retrieve the UE context based on the UE ID included in the reestablishment request message (514b). Upon determining the serving Gnb 104a as the last serving Gnb where the UE context may be stored, the target Gnb transmits the Retrieve UE context request (516b). The retrieve UE context request message (516b) includes at least the UE ID i.e. C-RNTI and PCI combination, the shortMAC-I, the PCI of the serving cell of the target Gnb 104b, the associated the NR DL-ARFCN and the target Cell ID.

The serving Gnb 104a identifies the stored UE context based on the UE ID included the retrieve UE context request message (516b). If the UE context is identified then the serving Gnb 104a is required to verify the UE 102 which sent the reestablishment request message (514b). Based on the identified UE context the serving Gnb determines the C-RNTI allocated to the UE 102 and the PCI of the last serving cell. The serving Gnb 104a calculates the authentication token based on the C-RNTI, PCI and target Cell ID using the last serving integrity protection security key i.e. KRRCint. The generated authentication token is shortened to 16 bits to get the shortMAC-I and compared with the shortMAC-I received in the retrieve UE context request message (516b). If the shortMAC-I comparison matches the UE 102 is considered authentic and verified by the serving Gnb 104a. In response to the request, the serving Gnb 104a transmits (518b) the Retrieve UE context response to the target Gnb 104b upon identifying and verifying the stored UE context. Upon successful identification and verification the serving Gnb 104a transfers the UE context to target Gnb 104b with the Retrieve UE context response message (518b). The serving Gnb 104a derives a new AS security key KgNB* which is always horizontally derived. The KgNB* is always derived if the context fetch on Xn is performed for re-establishment procedure. The [KgNB*, NCC] is provided to the target Gnb 104a along with the UE context in the Retrieve UE context response message (518b).

In an embodiment, the target Gnb 104b provides an explicit indicator in the Retrieve UE context request (516b) to the serving Gnb 104a to indicate whether the context fetch is for resume procedure or re-establishment procedure. If it is for re-establishment procedure the KgNB* is always horizontally derived. For e.g. the indicator may be set to “1” or “TRUE” to indicate the context fetch is for re-establishment procedure in which case the KgNB* is horizontally derived else the indictor may be set to “0” or “FALSE” to indicate the context fetch is for resume procedure in which the KgNB* is either vertically derived or horizontally derived. The indicator may be optionally included in the Retrieve UE context request message (516b). If present then the KgNB* is always horizontally derived indicating the context fetch is for re-establishment procedure and if absent then KgNB* is either vertically derived or horizontally derived indicating the context fetch is for resume procedure.

The UE 102 receives (520b) a reestablishment message (MSG4) on SRB1 from the target Gnb 104b if the UE context is successful retrieved; else the target Gnb 104b sends the setup message (MSG4) on SRB0. The received reestablishment message (520b) is encrypted and integrity protected using the new key i.e. KgNB* received from the UE context fetch procedure. The UE 102 decrypts the MSG4 using a new derived key KgNB* based on the horizontal key derivation which is determined based on the NCC available with UE when the re-establishment was triggered.

The UE 102 responds with MSG5 (522b) on SRB1 which is either reestablishment complete message if the MSG4 (520b) is reestablishment message on SRB1 else with setup complete message if the MSG4 (520b) is setup message on SRB0. The setup complete message is only integrity protected but not ciphered.

The target Gnb 104b initiates the path switch request (524b) towards the AMF 106 so that N2/N3 connection with the serving Gnb 104a is removed and established with the target Gnb 104a. Upon receiving the path switch request ACK (526b) the N2/N3 connection is established with the target Gnb 104b. The target Gnb 104b receives a new [NH, NCC] pair from the AMF 106 in the path switch request ACK (526b). This unused [NH, NCC] pair can be used by the target Gnb 104a to break the key chaining i.e. ensuring n-hop forward security wherein any further key refresh is based on vertical key derivation. The target Gnb 104b initiates the UE context release (528b) towards the serving Gnb 104a upon reception of the path switch request ACK (526b) from the AMF (106). The serving Gnb 104a deletes the UE context associated with UE 102 upon reception of the UE context release (528b) from the target Gnb 104b.

The above re-establishment procedure remains same regardless of the re-establishment trigger condition. In certain cases the target Gnb 104b and the serving Gnb 104a may be same when the re-establishment procedure is triggered; wherein the procedure depicted in FIG. 5B remains same except that the Xn procedures are executed with the same RAN node 104.

In an embodiment, either during the context fetch procedure or during Xn HO preparation procedure, the source Gnb provides the new key [KgNB*, NCC] value and also an indicator to indicate whether the KgNB* is derived using the horizontal key derivation or using vertical key derivation by the source Gnb. Based on the indicator provided by the source Gnb, the target Gnb's behavior is defined as follows:

In case of UE performing the resume procedure i.e. for RAN area paging update case, the target Gnb will wait for the path switch procedure to be completed, if the indicator indicates horizontal key derivation is performed by the Source Gnb to derive KgNB*. The target Gnb then uses the new NCC value received from the AMF during the PATH SWITCH procedure to include in the release message. The target Gnb uses the new NH, to break the KgNB chaining in a subsequent resume attempt. If the indicator indicates vertical key derivation is performed by the source Gnb to derive KgNB*, then the target Gnb uses the NCC received from the source Gnb to be included in the release message. If the indicator indicates vertical key derivation is performed by the source Gnb, the target Gnb does not wait for the path switch procedure to be completed, as it need not break the KgNB chain (if it is vertical key derivation then it is the first hop). The new NH value received in the PATH SWITCH procedure is used later, to break the key KgNB chain.

In case of UE performing the re-establishment procedure, if the indicator indicates horizontal key derivation is performed by the source Gnb, then the target Gnb uses the received KgNB* from the source Gnb as the KgNB and protect (encryption and/or integrity protection) the MSG4 i.e. reestablishment message. The UE shall also perform horizontal key derivation and use the derived keys to handle the reception of MSG4 i.e. reestablishment message on SRB1. If the indicator indicates vertical key derivation is performed by the source Gnb, then the target Gnb initiates RRC Setup message to the UE and then activates the received KgNB*. The target Gnb transmits RRC Setup message to the UE which includes the NCC received from the source Gnb.

In another embodiment during the context fetch procedure an indicator is included by the target Gnb to indicate to the source Gnb whether the context fetch or context 47etrieval procedure is triggered either for the resume procedure or re-establishment procedure. In case of UE performing the re-establishment procedure, if the indicator from the target Gnb to the source/serving Gnb indicates context fetch for re-establishment procedure then horizontal key derivation is performed by the source/serving Gnb. The target Gnb uses the received KgNB* from the source Gnb which is horizontally derived to protect (encryption and/or integrity protection) the MSG4 i.e. reestablishment message sent on SRB1.

In case of UE performing the resume procedure, if the indicator from the target Gnb to the source/serving Gnb indicates context fetch for resume procedure then horizontal key derivation or vertical key derivation is performed by the source/serving Gnb to derive the KgNB* based on the NCC provided to the UE in release message. The target Gnb uses the received KgNB* from the source Gnb which is either horizontally or vertically derived to protect (encryption and/or integrity protection) the MSG4 i.e. resume message sent on SRB1.

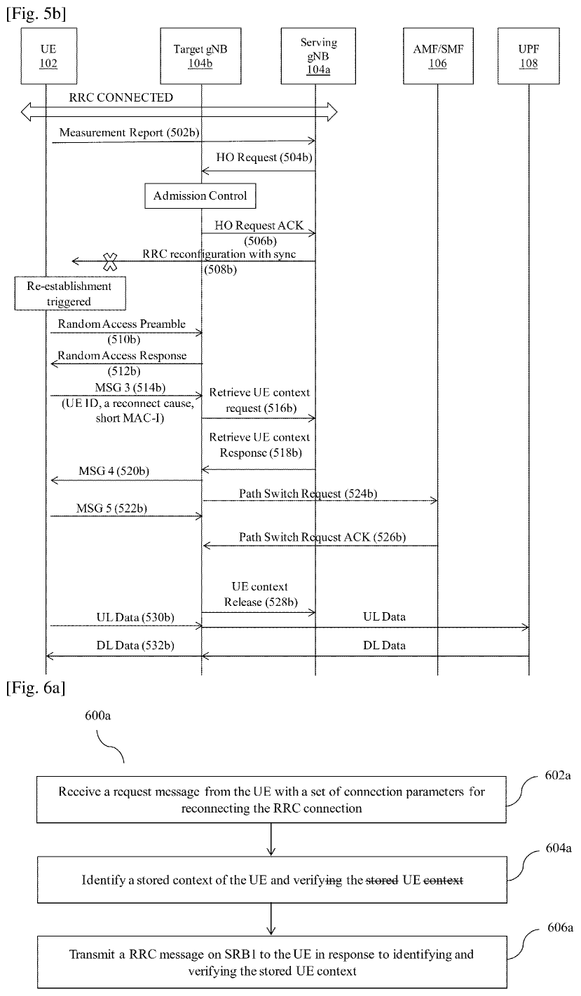

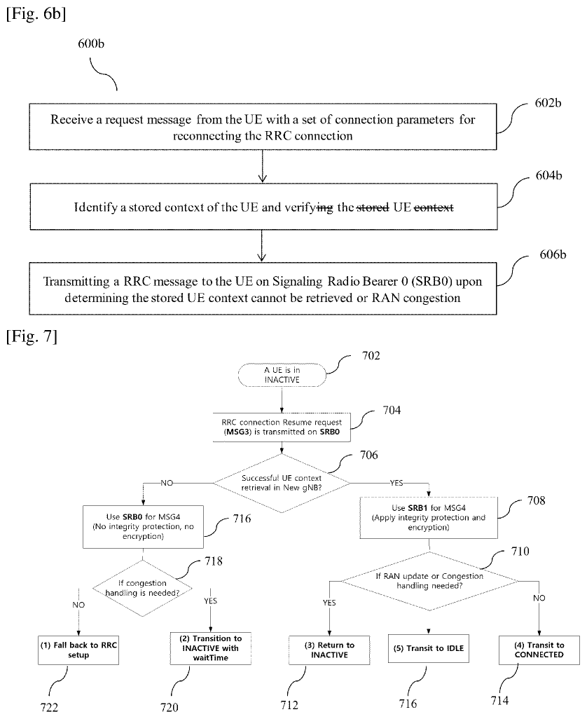

FIG. 6A is a flow diagram 600a illustrating a method for reconnecting a RRC connection of the UE 102 by the RAN node 104, in a wireless communication system, according to an embodiment as disclosed herein

At step 602a, the method includes receiving a request message from the UE with a set of connection parameters for reconnecting the RRC connection. The RAN node 104 is configured to receive the request message from the UE 102 with the set of connection parameters for reconnecting the RRC connection.

In an embodiment, the request message received from the UE 102 is a resume request message.

In another embodiment, request message received from the UE 102a is a reestablishment request message for reestablishing the RRC connection.

At step 604a, the method includes identifying a stored context of the UE 102 and verifying the UE which sent the request message in step 602a. The RAN node 104 is configured to identify the stored context of the UE 102 and verify the UE which sent the request. The RAN node 104 identifies the stored context of the UE 102 based on the UE ID i.e. either the Resume ID or C-RNTI and PCI combination and verifies the UE based on the authentication token I.e. shortMAC-I. The UE verification based on the authentication token is performed by the last serving Gnb where the UE context is stored.

At step 606a, the method includes transmitting a RRC message on SRB1 to the UE 102 in response to identifying and verifying the stored UE context. The RAN node 104 is configured to transmit the RRC message on SRB1 to the UE 102 in response to identifying and verifying the stored UE context.

In an embodiment, the RAN node 104 transmits a resume message to the UE on SRB1 in response to receiving the resume request message from the UE 102, after retrieving the UE context by identifying and verifying the stored UE context.

In another embodiment, the RAN node 104 transmits a reestablishment message to the UE 102 on SRB1 in response to the reestablishment request message, after retrieving the UE context by identifying and verifying the stored UE context.

FIG. 6B is a flow diagram 600b illustrating a method for reconnecting a RRC connection of the UE 102 by the RAN node 104, in a wireless communication system, according to an embodiment as disclosed herein.

At step 602b, the method includes receiving a request message from the UE with a set of connection parameters for reconnecting the RRC connection. The RAN node 104 is configured to receive the request message from the UE 102 with the set of connection parameters for reconnecting the RRC connection.

In an embodiment, the request message received from the UE 102 is a resume request message.

In another embodiment, request message received from the UE 102a is a reestablishment request message for reestablishing the RRC connection.

At step 604b, the method includes identifying a stored context of the UE 102 and verifying the UE which sent the request message in step 602b. The RAN node 104 is configured to identify the stored context of the UE 102 and verify the UE which sent the request. The RAN node 104 identifies the stored context of the UE 102 based on the UE ID i.e. either the Resume ID or C-RNTI and PCI combination and verifies the UE based on the authentication token I.e. shortMAC-I. The UE verification based on the authentication token is performed by the last serving Gnb where the UE context is stored.

At step 606b, the method includes transmitting a RRC message to the UE on SRB0 upon determining the stored UE context cannot be retrieved or RAN congestion or overload conditions encountered. The RAN node 104 is configured to transmit the RRC message to the UE on SRB0 upon determining the stored UE context cannot be retrieved or RAN congestion condition encountered.

In an embodiment, the RAN node 104 transmits a Reject message to the UE on SRB0 in response to the resume request message when there exists a RAN congestion condition or RAN overload condition encountered.

In an embodiment, the RAN node 104 transmits a Setup message to the UE 102 on SRB0 in response to the resume request message from the UE when the context of the UE is not retrieved.

In another embodiment, the RAN node 104 transmits a Setup message to the UE 102 on SRB0 in response to the reestablishment request message from the UE 102 when the context of the UE is not retrieved.

The various actions, acts, blocks, steps, or the like in the flow chart 600 may be performed in the order presented, in a different order or simultaneously. Further, in some embodiments, some of the actions, acts, blocks, steps, or the like may be omitted, added, modified, skipped, or the like without departing from the scope of the invention.

FIG. 7 is a flow diagram 700 illustrating various steps performed by the RAN node based on retrieval of a stored context of the UE, according to an embodiment as disclosed herein.

At step 702, the UE 102 is in inactive state and at step 704, the RAN node 104 receives the resume request on SRB0. At step 706, the RAN node 104 determines whether it has successfully retrieved the UE context in new Gnb i.e. the target Gnb on which the resume request was sent.

When the UE context retrieval and verification is successful then at step 708, the RAN node uses SRB1 to transmit MSG4 (i.e., a resume message, in response to the resume request from the UE 102). The MSG4 is integrity protected and encrypted using the new key i.e. KRRCint and KRRCenc. If the new Gnb is not congested at step 710, then at step 712, the RAN node 104 allows the UE 102 (by accepting the resume request message) to resume the connection and the UE 102 performs transition to connected state. The UE 102 upon receiving MSG4 on SRB1, decrypts the MSG4 with new key derived from either horizontal key derivation or vertical key derivation. Since MSG4 is integrity protected so the PDCP layer computes the full MAC-I for new Gnb verification. Upon integrity check pass, the UE 102 activates the stored UE context and sends MSG5 on SRB1 which is integrity protected and encrypted using the new key.

If the new Gnb is congested or the MSG3 was initiated for RAN paging area update at step 710, then at step 712, the MSG4 is sent on SRB1 (integrity protected and encrypted) which includes an indicator (either implicit indicator or explicit indicator) informing the UE 102 to stay in the inactive state or move to idle state. In case of RAN paging area update the UE is moved back to inactive state by sending MSG4 on SRB1. Upon receiving MSG4 on SRB1 i.e. the release message, the UE 102 decrypts the MSG4 with new key derived from either horizontal key derivation or vertical derivation to obtain the new Resume ID, new RAN paging parameters and new NCC. Since MSG4 is integrity protected so the PDCP layer computes the full MAC-I for new Gnb verification. Upon integrity check pass, the UE 102 checks the contents of MSG4 which includes the indicator to stay in inactive state and may include new resume ID, RAN paging area code, RAN paging DRX cycle and new NCC.

For some reason like congestion, even after successful context retrieval and UE verification, the new Gnb intends to not resume the connection then the MSG4 is sent on SRB1 i.e. release message, with the indicator (either implicit indicator or explicit indicator) informing the UE to move to IDLE state. In another scenario when the UE context retrieval fails when UE context is either not identified by old Gnb i.e. last serving Gnb or UE verification fails then new Gnb i.e. target Gnb sends MSG4 on SRB0 at step 716. If the new Gnb is congested or admission control does not allow the UE 102, then MSG4 on SRB0 i.e. reject message can include wait time interval value and Nonce informing the UE 102 to move back to INACTIVE state at step 720.

In another scenario, when the UE context retrieval fails when UE context is either not identified by old Gnb i.e. last serving Gnb or UE verification fails then new Gnb sends MSG4 on SRB0. However, if the new Gnb is not congested at step 718, then the new Gnb allows the UE 102 to resume the RRC connection with MSG4 transmission on SRB0 i.e. setup message indicating the UE 102 to fallback at step 722. On receiving MSG4 on SRB0 with fallback indication i.e. setup message, the UE 102 does not have to start a new RACH procedure. The UE 102 informs to NAS layer about fallback, discards the stored UE context, releases the resume ID. NAS layer on receiving fallback indication sends NAS PDU (i.e., service request/attach request) to AS layer. In MSG5, the UE 102 includes the NAS PDU and transmits MSG5 on SRB1 which is integrity protected with the new key. However, the MSG5 is not encrypted.

The above RRC connection resumption cases can be summarized as follows:

MSG4 on SRB1: Successful resumption

MSG4 on SRB1: Remain in INACTIVE (e.g. following RAN paging area update)

MSG4 on SRB1: Move to IDLE (e.g. congestion or some other reason)

MSG4 on SRB0: Fallback to RRC setup.

MSG4 on SRB0: Reject to INACTIVE (e.g. admission control does not allow)

The various actions, acts, blocks, steps, or the like in the flow chart 700 may be performed in the order presented, in a different order or simultaneously. Further, in some embodiments, some of the actions, acts, blocks, steps, or the like may be omitted, added, modified, skipped, or the like without departing from the scope of the invention.

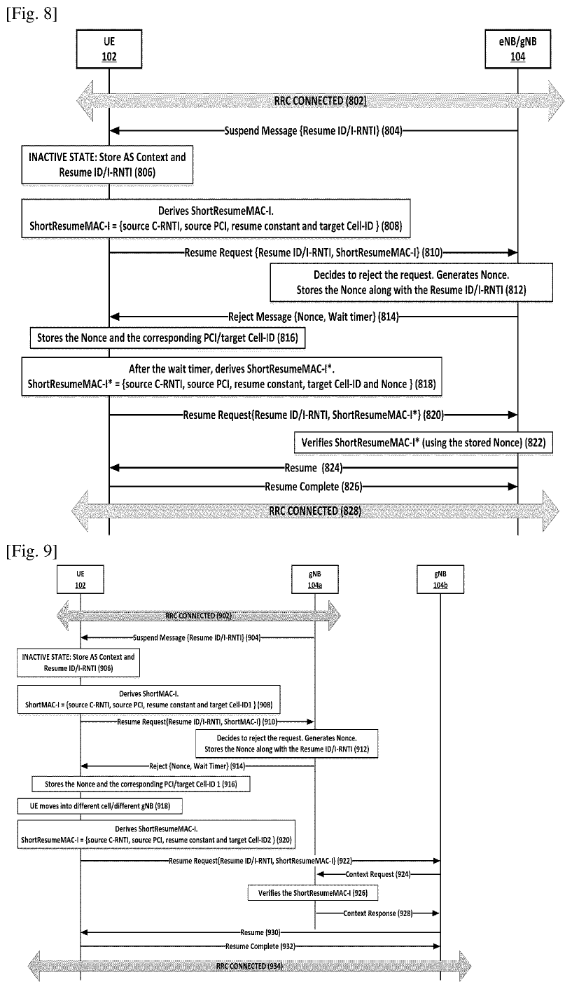

FIG. 8 is a sequence diagram in which the UE resumes the RRC connection with a RAN node using a nonce generated by the RAN node, according to the embodiments as disclosed herein.

As depicted in the FIG. 8, the UE 102 is in RRC connection (802) with the Enb/Gnb 104. The UE 102 receives (804) a suspend message with Resume ID/I-RNTI. The Resume ID or I-RNTI is a unique identification used by the Enb/Gnb 104 to identify the UE context for RRC_INACTIVE. After receiving the suspend message from the Enb/Gnb 104, the UE 102 enters the INACTIVE state and stores (806) the context and Resume ID or I-RNTI.

Further, the UE 102 derives (808) a first authentication token (i.e., a ShortresumeMAC-I) using a source C-RNTI, a source PCI, a resume constant and a target cell ID (i.e., cell ID of Enb/Gnb 104). With the first authentication token, the UE 102 transmits (810) a Resume request message including Resume ID or I-RNTI and ShortresumeMAC-I.

The Enb/Gnb 104 decides (812) to reject the Resume request message. The Enb/Gnb 104 when rejecting the Resume request message, generates and provides (814) a Nonce and a wait timer to the UE 102 in the Reject message. In an embodiment, the Nonce is used as the freshness parameter. The Enb/Gnb 104 stores the Nonce provided to the UE 102 along with the UE context (for example, along with the Resume ID/I-RNTI). The Resume ID or I-RNTI is unique identification used to identify the UE context for RRC_INACTIVE.

The UE 102 also stores (816) the Nonce along with the PCI/target Cell-ID of the cell which rejected the resume message. The UE 102 initiates the wait timer and upon expiry of the wait time interval, the UE 102 derives (818) a second authentication token (i.e., a shortResume MAC-I*) using the source C-RNTI, the source PCI, the resume constant, target cell ID and the Nonce (received from the Enb/Gnb 104).

When the UE 102 decides to send a re-attempt of Resume Request (i.e., after the wait timer expiry), the UE calculates the ShortResumeMAC-I* using the Nonce as one of the parameter along with other inputs parameters as mentioned above. Further, the UE 102 includes the derived ShortResumeMAC-I* and Resume ID/I-RNTI in the re-attempt Resume Request message (820). Once the Enb/Gnb 104 receives the Resume Request along with the ShartResumeMAC-I* and Resume ID/I-RNTI, the Enb/Gnb 104 retrieves the UE context including the AS security context (if available) and the Nonce provided. The Enb/Gnb calculates and verifies (822) the ShortResumeMAC-I” (using the Nonce). If the verification is successful, then the rest of the Resume procedure continues, in which the Enb/Gnb 104 transmits (824) a Resume message to the UE 102 and the UE 102 responds (826) with a Resume complete message. After completion of resume procedure, the UE enters (828) RRC CONNECTED state. If verification failed, then the Enb/Gnb commands the UE 102 to perform normal connection request. Above message flow indicates, the nonce is used in the ShortResumeMAC-I* derivation, only when the UE resumes in the cell/Gnb i.e. (corresponding target Cell-ID which provides the Nonce).

The message names i.e. Suspend message, Resume Request message, Reject message, Resume message and Resume Complete message are exemplary names for the RRC messages. Instead of message name as suspend a message name like Release message can used where the UE is suspended and provided with Resume ID/I-RNTI. Instead of Resume Request message name a message name like Re-Connect Request message can be used where the UE includes the ShortResumeMAC-I or ShortResumeMAC-I* and the Resume ID/I-RNTI along with the resume cause. Similarly instead of Resume and Resume Complete the message names can be Re-Connect and Re-Connect Complete. Regardless of the message names the functionality does not change. For the calculation of ShortResumeMAC-I or ShortResumeMAC-I* the resume constant may or may not be used.

FIG. 9 is a sequence diagram in which the UE resumes a RRC connection with another RAN node during mobility, according to the embodiments as disclosed herein

As depicted in the FIG. 9, the UE 102 is in RRC connection (902) with the Gnb 104a. The UE 102 receives (904) a suspend message with Resume ID/I-RNTI. The Resume ID or I-RNTI is a unique identification used by the Gnb 104a to identify the UE context for RRC_INACTIVE. After receiving the suspend message from the Gnb 104a, the UE 102 enters the INACTIVE state and stores (906) the context and Resume ID or I-RNTI.

Further, the UE 102 derives (908) a first authentication token (i.e., a ShortresumeMAC-I) using a source C-RNTI, a source PCI, a resume constant and a target cell ID. With the first authentication token, the UE 102 transmits (910) a Resume request message including Resume ID or I-RNTI and ShortResume MAC-I.

The Gnb 104a decides (912) to reject the Resume request message. The Gnb 104a when rejecting the resume request message, generates and provides (914) a Nonce and a wait timer to the UE 102 in the Reject message. In an embodiment, the Nonce is used as the freshness parameter. The Gnb 104a stores the Nonce provided to the UE 102 along with the UE context (for example, along with the Resume ID/I-RNTI). The Resume ID or I-RNTI is unique identification used to identify the UE context for RRC_INACTIVE.

The UE 102 also stores (916) the Nonce along with the PCI/target Cell-ID of the cell which rejected the resume message. Further, the UE 102 moves (918) to a different cell or to a different Gnb (i.e., Gnb104b).

The UE 102 derives (920) the second authentication token (i.e., ShortResumeMAC-I). The nonce is not used in the ShortResumeMAC-I derivation. When the UE resumes in the different cell/different Gnb (i.e. different target Cell-ID 104b is used than the corresponding target Cell-ID 104a which provides the Nonce). Further, the UE 102 includes the derived ShortResumeMAC-I and Resume ID/I-RNTI in the re-attempt Resume request message transmitted (922) to the Gnb 104b. In response to receiving the Resume request message, the Gnb 104b transmits (924) a context request to the Gnb 104a for retrieving the context of the UE 102. The Gnb 104a verifies (926) the ShortResumeMAC-I and after verification, the Gnb 104a transmits (928) the context of the UE 102.

If the verification is successful, then the rest of the Resume procedure, in which the Gnb 104b transmits (930) a Resume message to the UE 102 and the UE 102 responds (932) with a Resume complete message. After completion of resume procedure, the UE enters (934) RRC CONNECTED state. If verification is failed, then the Gnb 104b commands the UE to perform normal connection request.

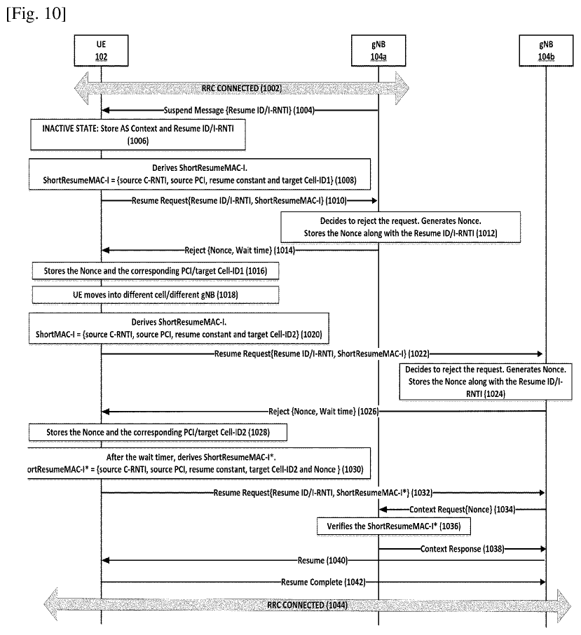

FIG. 10 is a sequence diagram in which the resumes a RRC connection with another RAN node using a nonce where the nonce is provided by the another RAN node, according to the embodiments as disclosed herein

As depicted in the FIG. 10, the UE 102 is in RRC connection (1002) with the Gnb 104a. The UE 102 receives (1004) a suspend message with Resume ID/I-RNTI from the Gnb 104a. The Resume ID or I-RNTI is a unique identification used by the Gnb 104a to identify the UE context for RRC_INACTIVE. After receiving the suspend message from the Gnb 104a, the UE 102 enters the INACTIVE state and stores (1006) the context and Resume ID or I-RNTI.

Further, the UE 102 derives (1008) a first authentication token (i.e., a ShortResumeMAC-I) using a source C-RNTI, a source PCI, a resume constant and a target cell ID. With the first authentication token, the UE 102 transmits (1010) a Resume request message including Resume ID or I-RNTI and the ShortResume MAC-I.

The Gnb 104a decides (1012) to reject the Resume request message. The Gnb 104a when rejecting the Resume request message, generates and provides (1014) a Nonce and a wait timer to the UE 102 in the Reject message.

In an embodiment, the Nonce is used as the freshness parameter. The Gnb 104a stores the Nonce provided to the UE 102 along with the UE context (for example, along with the Resume ID/I-RNTI). The Resume ID or I-RNTI is unique identification used to identify the UE context for RRC INACTIVE.

The UE 102 also stores (1016) the Nonce along with the PCI/target Cell-ID of the cell which rejected the resume message. Further, the UE 102 moves (1018) to a different cell or to a different Gnb (i.e., Gnb104b).

The UE 102 derives (1020) the second authentication token (i.e., ShortResumeMAC-I). The nonce is not used in the ShortResumeMAC-I derivation. When the UE resumes in the different cell/different Gnb (i.e. different target Cell-ID is used than the corresponding target Cell-ID which provides the Nonce). This is because target Cell-ID is used in the ShortResumeMAC-I calculation which will be different than the ShortResumeMAC-I sent to Gnb 104a. Further, the UE 102 includes the derived ShortResumeMAC-I and Resume ID/I-RNTI in the re-attempt Resume request message transmitted (1022) to the Gnb 104b.

The Gnb 104b decides (1024) to reject the Resume request message. The Gnb 104b when rejecting the Resume request message, generates and provides (1026) a Nonce and a wait timer to the UE 102 in the Reject message.

Thus, in the FIG. 10, the resume request message sent to target Gnb 104b is also rejected and the UE 102 receives nonce from target Gnb 104b. The target Gnb 104b provided nonce is used in the ShortResumeMAC-I* derivation, when the UE 102 initiates resume request in the target Gnb 104b. If the target Cell-ID is different, then freshness parameter (i.e. nonce) is not used for ShortResumeMAC-I derivation. The Gnb 104b stores the Nonce provided to the UE 102 along with the UE context (for example, along with the Resume ID/I-RNTI). The Resume ID or I-RNTI is unique identification used to identify the UE context for RRC_INACTIVE.

The UE 102 also stores (1028) the Nonce along with the PCI/target Cell-ID of the cell which rejected the resume message. The UE 102 initiates the wait timer and upon expiry of the wait time interval, the UE 102 derives (1030) a second authentication token (i.e., a shortResume MAC-I*) using the source C-RNTI, the source PCI, the resume constant, target cell ID and the Nonce (received from the Gnb 104a).

When the UE 102 decides to send a re-attempt of Resume Request (i.e., after the wait timer expiry), the UE 102 calculates the ShortResumeMAC-I* using the Nonce as one of the parameter along with other inputs parameters as mentioned above. Further, the UE 102 includes the derived ShortResumeMAC-I* and Resume ID/I-RNTI in the re-attempt Resume Request message (1032).

In response to receiving the Resume request message, the Gnb 104b transmits (1034) a context request to the Gnb 104a for retrieving the context of the UE 102 using the Nonce. The Gnb 104a verifies (1036) the ShortResumeMAC-I* and after verification, the Gnb 104a transmits (1038) the context of the UE 102. The Gnb 104b provides the stored Nonce value along with the ShortResumeMAC-I* to the Gnb 104a for verification. The Gnb 104a derives the ShortResumeMAC-I* using the Nonce provided by the target Gnb 104b as one of the input parameter for ShortResumeMAC-I* derivation and verifies the ShortResumeMAC-I*.

If the verification is successful, then the rest of the Resume procedure, in which the Gnb 104b transmits (1040) a Resume message to the UE 102 and the UE 102 responds (1042) with a Resume complete message. After completion of resume procedure, the UE enters (1044) RRC CONNECTED state. If verification is failed, then the Gnb 104b commands the UE to perform normal connection request.

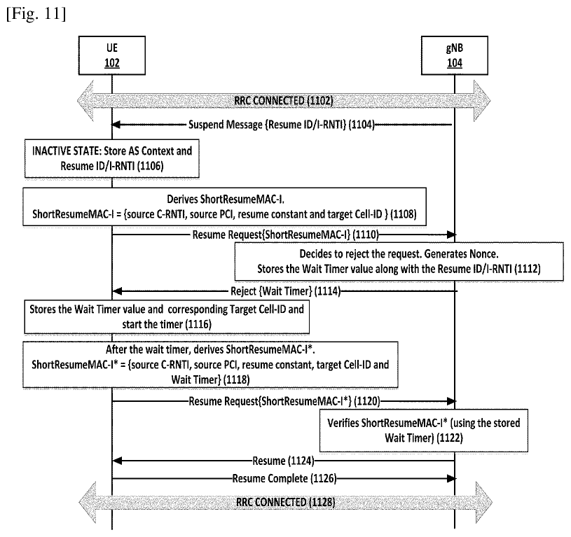

FIG. 11 is a sequence diagram in which the UE resumes the RRC connection with the RAN node using a wait timer value, according to the embodiments as disclosed herein

The steps 1102 to 1112 in the FIG. 11 are same as that of the steps 802 to 812 as in the FIG. 8. The Gnb 104a, when rejecting the Resume request, provides (1114) a wait Timer value to the UE 102 in the Reject message. The Gnb 104a stores the wait Time value provided to the UE 102 along with the UE context (for example, along with the Resume ID/I-RNTI). The UE 102 also stores (1116) the wait Time along with the target Cell-ID.

The UE 102 resumes in the same Gnb 104a). When the UE 102 decides to send Resume Request re-attempt (may be after the wait timer expiry), the UE calculates (1118) the second authentication token (i.e., ShortResumeMAC-I*) using the wait Timer value as one of the parameter along with other inputs parameters. Then the UE 102 includes (1120) the derived ShortResumeMAC-I* in the Resume Request message. Once the Gnb 104 receives the Resume Request along with the ShortResumeMAC-I*, the Gnb 104 retrieves the UE context including the AS security context and the waitTime value provided. The Gnb calculates and verifies (1122) the ShortResumeMAC-I* (using the wait Time value). If the verification is successful, then the rest of the RRC Connection Resume procedure continues in which the Gnb 104 transmits (1124) a Resume message to the UE 102 and the UE 102 responds (1126) with a Resume complete message. After completion of resume procedure the UE 102 enters RRC CONNECTED state. If verification failed, then the Gnb commands the UE 102 to perform normal connection request.

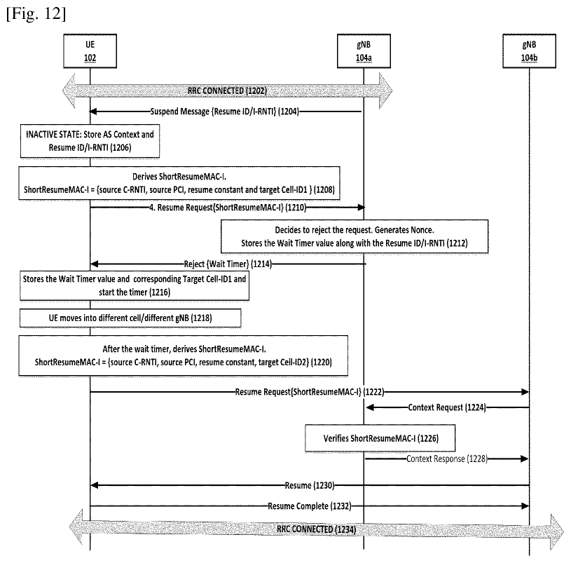

FIG. 12 is a sequences diagram in which the UE resumes the RRC connection in another RAN node using a cell Identifier of another node, according to the embodiments as disclosed herein.

The steps 1202 to 1212 in the FIG. 12 are same as that of the steps 902 to 912 as in the FIG. 9. The Gnb 104a, when rejecting the Resume request, provides (1214) a wait Timer value to the UE in the Reject message. The Gnb 104a stores the wait Time value provided to the UE along with the UE context (for example, along with the Resume ID/I-RNTI). The UE also stores (1216) the wait Time along with the target Cell-ID1.

In the steps 1218 to 1230, the UE 102 resumes in the Gnb 104b. The wait Time is used in the ShortResumeMAC-I* derivation, only when the UE 102 resumes in the same Gnb (the corresponding target Cell-ID which provides the waitTime). If the target Cell-ID is different, where the UE 102 makes resume request re-attempt then freshness parameter is not used for ShortResumeMAC-I derivation. As shown in the FIG. 12, the UE 102 moves (1218) to another cell of Gnb 104b. Upon expiry of wait Timer, the UE derives (1220) a shortResumeMAC-I using input parameters as source PCI, C-RNTI, target Cell-ID2 and resume constant. The shortResumeMAC-I calculated at step 1208 is different than the shortResumeMAC-I calculated at step 1220 since the target Cell-ID value is different. If the verification is successful, then the rest of the Resume procedure continues, in which the Gnb 104b transmits (1230) a Resume message to the UE 102 and the UE 102 responds (1232) with a Resume complete message. After completion of resume procedure the UE enters (1234) RRC CONNECTED state. If verification failed, then the Gnb 104b commands the UE to perform normal connection request.

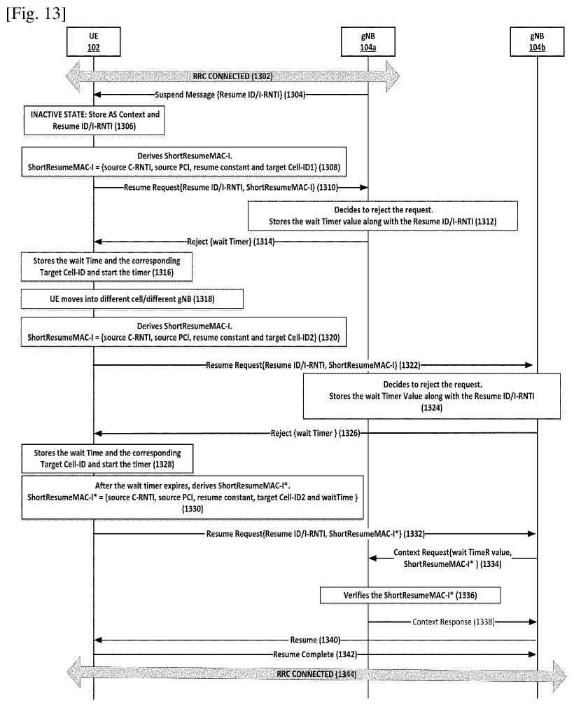

FIG. 13 is a sequence diagram in which the UE resumes the RRC connection using a wait Timer provided by another RAN node, according to the embodiments as disclosed herein

The steps 1302 to 1312 in the FIG. 21 are same as that of the steps 902 to 912 as in the FIG. 9. The Gnb 104a, when rejecting the Resume request, provides (1314) a wait Timer value to the UE 102 in the Reject message. The Gnb 104a stores the wait Time value provided to the UE 102 along with the UE context (for example, along with the Resume ID/I-RNTI). The UE also stores (1316) the wait Time along with the target Cell-ID1.

In the steps 1318 to 1326, (the UE 102 resumes in the new Gnb 104b): The wait Time is used in the ShortResumeMAC-I* derivation, only when the UE resumes in the same Gnb (corresponding target Cell-ID which provides the waitTime). If the target Cell-ID is different, where the UE 102 makes resume request re-attempt then freshness parameter is not used for ShortResumeMAC-I derivation. As shown in the FIG. 13, the UE 102 moves (1318) to another cell of Gnb-2. Upon expiry of wait Timer the UE derives (1320) shortResumeMAC-I using input parameters as source PCI, C-RNTI, target Cell-ID2 and resume constant. The shortResumeMAC-I calculated at step 1308 is different than the shortResumeMAC-I calculated at step 1320 since the target Cell-ID value is different. The Gnb 104b, when rejecting the Resume request, provides a wait Timer value to the UE in the Reject message at step 1326. The Gnb 104b stores the wait Time value provided to the UE along with the UE context (i.e. along with the Resume ID/I-RNTI).

Steps 1328 to 1342 (UE re-attempt in the Gnb 104b): The UE 102 also stores (1328) the wait Time provided by Gnb 104b along with the target Cell-ID2. The Gnb 104b provided wait Timer value is used in the ShortResumeMAC-I* derivation at step 1330. The UE 102 initiates resume request re-attempt in the same Gnb (i.e. Gnb 104b) after the wait timer expire. Since the target Cell-ID is same, then freshness parameter is used for ShortResumeMAC-I* derivation. Upon receiving the resume request from the UE 102 at step 1332, the new Gnb (i.e. Gnb 104b) provides the stored wait Time value along with the ShortResumeMAC-I* to the old Gnb (i.e., Gnb 104a) for verification. The old Gnb (i.e. Gnb 104a) derives the ShortResumeMAC-I* using the wait Time provided by the new Gnb (i.e., Gnb 104b) as one of the input parameter for ShortResumeMAC-I* derivation and verifies the ShortResumeMAC-I* at step 1336. If the verification is successful, then the rest of the Resume procedure continues in which the Gnb 104b transmits (1340) a Resume message to the UE 102 and the UE 102 responds (1342) with a Resume complete message. After completion of resume procedure the UE enters (1344) RRC CONNECTED state. If verification failed, then the Gnb 104b commands the UE to perform normal connection request.

In an embodiment, the ShortResumeMAC-I* calculation using waitTime is as follows:

ShortResumeMAC-I*=negotiated EIA-algorithm {VarShortResumeMAC-Input, Key, Other possible input parameters}

Where, VarShortResumeMAC-Input={source C-RNTI, source PCI, resume constant, target Cell-ID, waitTime}

In an another embodiment, the ShortResumeMAC-I* calculation using waitTime is as follows:

ShortResumeMAC-I*=negotiated EIA-algorithm {VarShortResumeMAC-Input, Key, Other possible input parameters}

Where, VarShortResumeMAC-Input={source C-RNTI, source PCI, resume constant, target Cell-ID, [waitTime, waitTime]}.

The waitTime is included twice means the value is concatenated as [waitTime, waitTime], as to increase the size of the freshness parameter.

In an another embodiment, the ShortResumeMAC-I* calculation using waitTime is as follows:

ShortResumeMAC-I*=negotiated EIA-algorithm {VarShortResumeMAC-Input, Key, Other possible input parameters}

Where, VarShortResumeMAC-Input={source C-RNTI, source PCI, resume constant, target Cell-ID, sum of the waitTime values}

waitTime is included as sum of all the previously received waitTime values when the resume request was rejected repeatedly by the same gNB.

In an another embodiment, the ShortResumeMAC-I* calculation using waitTime is as follows:

ShortResumeMAC-I*=negotiated EIA-algorithm {VarShortResumeMAC-Input, Key, Other possible input parameters}

Where, VarShortResumeMAC-Input={source C-RNTI, source PCI, resume constant, target Cell-ID, [waitTime #1, waitTime #2, waitTime #3]}

The waitTime is included multiple times means the value is concatenated as [waitTime #1, waitTime #2, waitTime #3], as to increase the size of the freshness parameter where waitTime #1, waitTime #2 and waitTime #3 are previously received waitTime values when the resume request was rejected repeatedly by the same gNB.

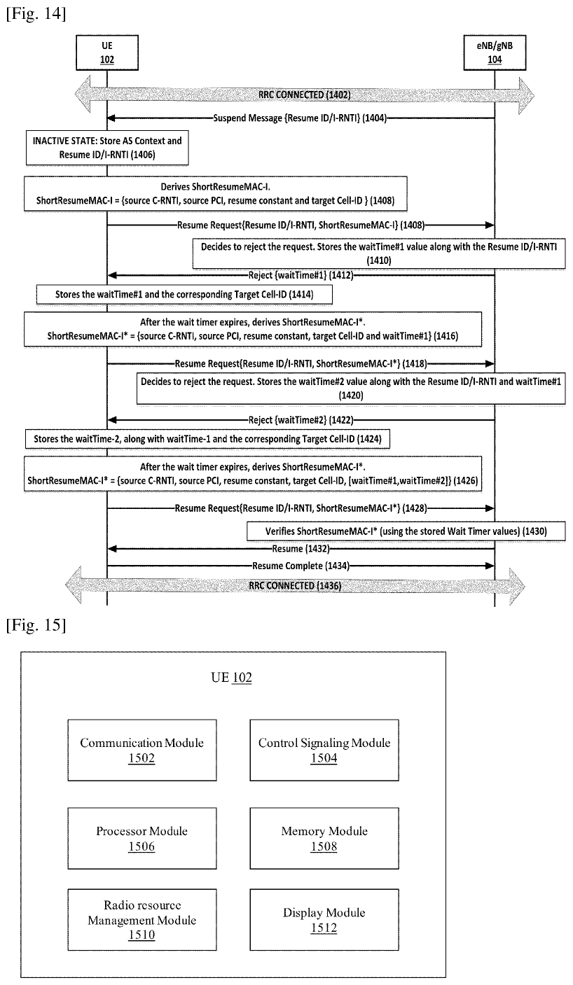

FIG. 14 is a sequence diagram in which the UE resumes the RRC connection with the RAN node using the wait Timers, according to the embodiments as disclosed herein. The FIG. 14 depicts a similar method as depicted in the sequence diagram in the FIG. 11. However, in the FIG. 14, the eNB/gNB 104 rejects the resume request message of UE 102 by transmitting the reject message to the UE 102 by including different wait timers (i.e., wait timer #1 and wait timer #2) at steps 1412 and 1422 respectively. At step 1416, the UE 102 derives shortResumeMAC-I* using wait timer #1 along with other connection parameters. Further, at step 1426, the UE 102 derives shortResumeMAC-I* using stored wait timer values (i.e., the wait timer #1 and the wait timer #2). The eNB/gNB 104 verifies the shortResumeMAC-I* using stored wait timer values at step 1430.

If the verification is successful, then the rest of the Resume procedure continues in which the gNB 104b transmits (1432) a Resume message to the UE 102 and the UE 102 responds (1434) with a Resume complete message. After completion of resume procedure the UE enters (1436) RRC CONNECTED state. If verification failed, then the gNB 104b commands the UE to perform normal connection request.

FIG. 15 is a block diagram illustrating various modules of the UE 102, according to an embodiment as disclosed herein.

The primary blocks present for communication include a communication module 1502, a control signaling module 1504, a processor module 1506, a memory module 1508, a radio resource management module 1510 and a display module 1512. In an embodiment, the communication module 1502 is configured to communicate RRC signaling to and from the eNB/gNB 104. For example, the communication module 1502 in the UE 102 can be configured to communicate the RRC connection resume request message, RRC connection resume complete message, RRC connection reestablishment message or the like to the eNB/gNB 104. Further, the communication module 1502 in the UE 102 can perform random access procedure on the cell of eNB/gNB 104. Further, the communication module 1502 in the UE 102 can be configured to transmit and receive data from the eNB/gNB 104 according to physical layer waveform and coding assumed for next generation wireless system. The control signaling module 1504 in the UE 102 can be configured to prepare the related RRC messages to be transmitted to the eNB/gNB 104 and also can be configured to parse the related RRC messages received from the eNB/gNB 104. The processor module 1506 depicts a computing environment in the UE 102 for implementing a method for reconnecting a RRC connection with the eNB/gNB 104.

The computing environment of 1506 comprises at least one processing unit that is equipped with a control unit and an arithmetic logic unit (ALU), a clock chip, plurality of networking devices, and a plurality Input output (I/O) devices. The processor module 1506 is responsible for processing the instructions of the algorithm. The processing unit receives commands from the control unit in order to perform its processing. Further, any logical and arithmetic operations involved in the execution of the instructions are computed with the help of the ALU. The overall computing environment can be composed of multiple homogeneous or heterogeneous cores, multiple CPUs of different kinds, special media and other accelerators. The processing unit is responsible for processing the instructions of the algorithm. The algorithm comprising of instructions and codes required for the implementation are stored in either the memory module 1508 or the storage or both. At the time of execution, the instructions may be fetched from the corresponding memory module 1208 or storage unit, and executed by the processing unit. The processing unit synchronizes the operations and executes the instructions based on the timing signals generated by the clock chip. The embodiments of the present disclosure disclosed herein can be implemented through at least one software program running on at least one hardware device and performing network management functions to control the elements. Further, the memory module 1508 is also configured to store information related to UE operation. The radio resource management module 1510 in the UE 102 is responsible for various aspects like cell level mobility and beam level mobility etc. The radio resource management module 1510 in the UE 102 may be configured to evaluate the cell selection/re-selection handover events. The display module 1512 in the UE 102 can be configured so that user can input information or information can output on the display for the user to understand some UE 102 operations when the UE 102 is operating in dual connectivity mode of operation. Most of the UE 102 operations are transparent to the user and may not need user input nor output on the display.

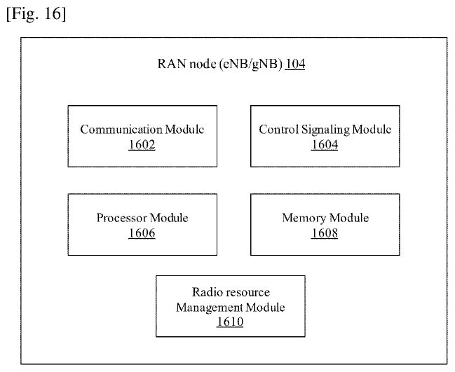

FIG. 16 is a block diagram illustrating various modules of the RAN node 104, according to an embodiment as disclosed herein.

The primary blocks present in the eNB/gNB 104 for communication with the UE 102 include a communication module 1602, a control signaling module 1604, a processor module 1606, a memory module 1608 and a radio resource management module 1610. In an embodiment of the present disclosure, the communication module 1602 is configured to communicate RRC signaling to and from the UE 102. For example, the communication module 1602 in the eNB/gNB 104 can be configured to receive the resume request message and the reestablishment request message from the UE 102 on SRB0. Further, the communication module 1602 in the eNB/gNB 104 can be configured to transmit the resume message, the reject message and the reestablishment message to the UE 102. The control signaling module 1604 in the eNB/gNB 104 can be configured to prepare the related RRC messages (as described above) to be transmitted to the UE 102 and also can be configured to parse the related RRC message received from the UE 102.

Further, the control signaling module 1604 in the eNB/gNB 104 can be configured to determine the bearer to be transmitted over within respective cells in the eNB/gNB 104. The bearer is a Signaling Radio Bearer (SRB), which can be SRB0 or SRB1. The processor module 1606 depicts a computing environment implementing the method for resuming the RRC connection of the UE in the wireless communication system. The computing environment of 1606 comprises at least one processing unit that is equipped with a control unit and an arithmetic logic unit (ALU), a clock chip, plurality of networking devices, and a plurality Input output (I/O) devices. The processor module 1606 is responsible for processing the instructions of the algorithm. The processing unit receives commands from the control unit in order to perform its processing. Further, any logical and arithmetic operations involved in the execution of the instructions are computed with the help of the ALU. The overall computing environment can be composed of multiple homogeneous or heterogeneous cores, multiple CPUs of different kinds, special media and other accelerators. The processing unit is responsible for processing the instructions of the algorithm. The algorithm comprising of instructions and codes required for the implementation are stored in either the memory module 1608 or the storage or both. At the time of execution, the instructions may be fetched from the corresponding memory module 1608 or storage unit, and executed by the processing unit. The processing unit synchronizes the operations and executes the instructions based on the timing signals generated by the clock chip. The embodiments of the present disclosure disclosed herein can be implemented through at least one software program running on at least one hardware device and performing network management functions to control the elements. The methods shown in the FIGS. 6A, 6B and 7 include various units, blocks, modules, or steps described in relation with methods, processes, algorithms, or systems of the present disclosure, which can be implemented using any general purpose processor and any combination of programming language, application, and embedded processor. Further, the memory module 1608 is also configured to store information related to operation of the eNB/gNB 104 and the UE 102. The memory module 1608 can be configured to store various UE related configurations and the UE context, when UE 102 is in connected mode. The radio resource management module 1610 in the eNB/gNB 104 may be configured to evaluate the handover decisions (based on the BRS measurement reports sent by one or more UEs 102a-102n). The radio resource management module 1610 in the eNB/gNB 104 can be configured to receive the CSI-RS RSRP measurements from the UEs 102a-10n.

The embodiments disclosed herein can be implemented using at least one software program running on at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A method for reconnecting a radio resource control (RRC) connection with a radio access network (RAN) node by a user equipment (UE) in a wireless communication system, the method comprising:
transmitting a message 3 (MSG3) of a random access procedure on a signaling radio bearer 0 (SRB0) for reconnecting the RRC connection to the RAN node;
receiving a message 4 (MSG4) of the random access procedure from the RAN node on one of the SRB0 and a signaling radio bearer 1 (SRB1); and
transmitting a message 5 (MSG5) on the SRB1 to the RAN node for reconnecting the RRC connection.

2. The method of claim 1, wherein the MSG3 is a request message to the RAN node with a set of connection parameters comprising at least one of a UE identifier (UE ID), a first authentication token, a reconnect cause value to reconnect the RRC connection and a next hop chaining counter (NCC),
wherein the UE ID is one of a resume identifier(Resume ID) referred as implicit radio network temporary identifier (I-RNTI), a last serving cell allocated C-RNTI and a last serving cell physical cell identifier (PCI) combination for identifying a UE context at the RAN node, and
wherein the first authentication token is a shortened message authentication code for integrity check referred as a ShortMAC-I, wherein the ShortMAC-I is determined using at least one of a last serving cell allocated C-RNTI, a last serving cell physical cell identifier (PCI), and a target cell ID calculated using a RRC integrity security key of last serving cell.

3. The method of claim 1, wherein the MSG3 for reconnecting the RRC connection is one of a resume request message transmitted to the RAN node to transition from an inactive state to a connected state and a reestablishment request message from the connected state to reestablish the RRC connection.

4. The method of claim 1, wherein the MSG4 received on the SRB0 is one of a reject message to indicate the UE to move to an inactive state and a setup message to indicate the UE to fallback to an idle state.

5. The method of claim 1, wherein the MSG4 received on the SRB1 is a RRC message responded to the request message to transition the UE to one of a connected state, an inactive state and an idle state, wherein the RRC message is integrity protected with a new RRC integrity security key and ciphered with a new RRC encryption security key,
wherein the new RRC integrity security key and new RRC encryption key used for security protection of RRC message is derived using one of a vertical key derivation and a horizontal key derivation,
wherein the RRC message received on the SRB1 is a resume message to indicate the UE to move to the connected state comprising parameters to resume data radio bearers (DRBs), and
wherein the RRC message received on the SRB1 is a release message comprising one of an explicit indicator and an implicit indicator to indicate the UE move either to the inactive state or the idle state.

6. The method of claim 1, wherein the MSG4 received on the SRB1 is a reestablishment message responded to the reestablishment request message, wherein the reestablishment message is integrity protected with a new RRC integrity security key and ciphered with a new RRC encryption security key, and
wherein the new RRC integrity security key and new RRC encryption key used for security protection of reestablishment message is derived using a horizontal key derivation.

7. The method of claim 4, wherein the reject message to indicate the UE to move to the inactive state, responded to a resume request message comprises at least one of a nonce and a wait time interval, and
the method further comprising:
retransmitting the resume request message to the RAN node after expiry of the wait time interval, wherein the retransmitted resume request comprises at least one of the UE ID, a second authentication token, and a reconnect cause value.

8. The method of claim 7, wherein the second authentication token is determined using at least one of a last serving cell allocated C-RNTI, a last serving cell physical cell identifier (PCI), a target cell ID and one of the nonce and the wait time interval calculated using a RRC integrity security key of last serving cell.

9.-11. (canceled)

12. A user equipment (UE) for reconnecting a radio resource control (RRC) connection with a radio access network (RAN) node in a wireless communication system, the UE comprising:
a transceiver; and
a processor coupled with the transceiver and configured to:
transmit a message 3 (MSG3) of a random access procedure on a signaling radio bearer 0 (SRB0) for reconnecting the RRC connection with the RAN node;
receive a message 4 (MSG4) of the random access procedure from the RAN node on one of: the SRB0 and a signaling radio bearer 1 (SRB1); and
transmit a message 5 (MSG5) on the SRB1 to the RAN node for reconnecting the RRC connection.

13. The UE of claim 12, wherein the MSG3 is a request message to the RAN node with a set of connection parameters comprising at least one of a UE identifier (UE ID), a first authentication token, a reconnect cause value to reconnect the RRC connection and a next hop chaining counter (NCC),
wherein the UE ID is one of a resume identifier(Resume ID) referred as implicit radio network temporary identifier (I-RNTI), a last serving cell allocated C-RNTI and a last serving cell physical cell identifier (PCI) combination for identifying a UE context at the RAN node, and
wherein the first authentication token is a shortened message authentication code for integrity check referred as a ShortMAC-I, wherein the ShortMAC-I is determined using at least one of a last serving cell allocated C-RNTI, a last serving cell physical cell identifier (PCI), and a target cell ID calculated using an RRC integrity security key of last serving cell.

14. A radio access network (RAN) node for reconnecting a radio resource control (RRC) connection of a user equipment (UE) in a wireless communication system, the RAN node comprising:
a transceiver; and
a processor coupled with the transceiver and configured to:
receive a request message from the UE with a set of connection parameters for reconnecting the RRC connection;
identify a stored context of the UE and verifying the stored UE context;
transmit a RRC message on signaling radio bearer 1 (SRB1) to the UE in response to retrieving the UE context by identifying and verifying the stored UE context; and
transmit a RRC message to the UE on signaling radio bearer 0 (SRB0) upon determining one of: the stored UE context is not retrieved and the RAN node is congested.

15. The RAN node of claim 14, wherein the processor is further configured to:
transmit a resume message to the UE on the SRB1 to indicate the UE to move to a connected state in response to a resume request message comprising a reconnect cause value indicating resuming the RRC connection, wherein the resume message includes parameters to resume data radio bearers (DRBs), or
transmit a release message to the UE on SRB1 to indicate the UE to move back to inactive state in response to the resume request message comprising a reconnect cause value indicating RAN paging area update; wherein the release message includes at least a new resume identifier (Resume ID), new paging parameters and a new NCC, or
transmit a release message to the UE on SRB1 to indicate the UE to move back to idle state in response to the resume request message, wherein the release message includes indicator to release the RRC connection.

16. The UE of claim 12, wherein the MSG3 for reconnecting the RRC connection is one of a resume request message transmitted to the RAN node to transition from an inactive state to a connected state and a reestablishment request message from the connected state to reestablish the RRC connection.

17. The UE of claim 12, wherein the MSG4 received on the SRB0 is one of a reject message to indicate the UE to move to an inactive state and a setup message to indicate the UE to fallback to an idle state.

18. The UE of claim 12, wherein the MSG4 received on the SRB1 is a RRC message responded to the request message to transition the UE to one of a connected state, an inactive state and an idle state, wherein the RRC message is integrity protected with a new RRC integrity security key and ciphered with a new RRC encryption security key,
wherein the new RRC integrity security key and new RRC encryption key used for security protection of RRC message is derived using one of a vertical key derivation and a horizontal key derivation,
wherein the RRC message received on the SRB1 is a resume message to indicate the UE to move to the connected state comprising parameters to resume data radio bearers (DRBs), and
wherein the RRC message received on the SRB1 is a release message comprising one of an explicit indicator and an implicit indicator to indicate the UE to move either to the inactive state or the idle state.

19. The UE of claim 12, wherein the MSG4 received on the SRB1 is a reestablishment message responded to the reestablishment request message, wherein the reestablishment message is integrity protected with a new RRC integrity security key and ciphered with a new RRC encryption security key, and
wherein the new RRC integrity security key and new RRC encryption key used for security protection of reestablishment message is derived using a horizontal key derivation.

20. The UE of claim 17, wherein the reject message to indicate the UE to move to the inactive state, responded to a resume request message comprises at least one of a nonce and a wait time interval, and
wherein the processor is further configured to retransmit the resume request message to the RAN node after expiry of the wait time interval, wherein the retransmitted resume request comprises at least one of the UE ID, a second authentication token, and a reconnect cause value.

21. The UE of claim 20, wherein the second authentication token is determined using at least one of a last serving cell allocated C-RNTI, a last serving cell physical cell Identifier (PCI), a target cell ID and one of the nonce and the wait time interval calculated using an RRC integrity security key of last serving cell.

22. The RAN node of claim 14, wherein the processor is further configured to:
transmit a reestablishment message to the UE on SRB1 in response to the reestablishment request message comprising a reconnect cause value indicating reestablishing the RRC connection, wherein the reestablishment message includes parameters to resume data radio bearers (DRBs), or
transmit a reject message to the UE on SRB0 in response to a resume request message upon determining a RAN congestion, or
transmit a setup message to the UE on SRB0 in response to one of the resume request message and reestablishment request message upon determining that the context of the UE is not retrieved.
